(19) United States
(12) Patent Application Publication
(10) Pub. No.: US 2023/0010259 A1
(43) Pub. Date: Jan. 12, 2023

(54) WAVELENGTH MULTIPLEXING/DEMULTIPLEXING DEVICE

(71) Applicant: SUMITOMO ELECTRIC INDUSTRIES, LTD., Osaka (JP)

(72) Inventors: Masato TANAKA, Osaka-shi (JP); Eiichiro YAMADA, Osaka-shi (JP); Hidehisa TAZAWA, Osaka-shi (JP); Osamu SHIMAKAWA, Osaka-shi (JP)

(73) Assignee: SUMITOMO ELECTRIC INDUSTRIES, LTD., Osaka (JP)

(21) Appl. No.: 17/852,576

(22) Filed: Jun. 29, 2022

(30) Foreign Application Priority Data
Jun. 30, 2021 (JP) 2021-108447

(51) Int. Cl. H04J 14/02; G02B 6/293

(52) U.S. Cl. CPC H04J 14/0227; G02B 6/2938; G02B 6/29365

(57) ABSTRACT

A wavelength multiplexing/demultiplexing device includes a first collimator, an M number of second collimators, and the M number of filters. The filters have transmission wavelength bands differing from each other. An optical path connecting the first collimator and the second collimator in first order to each other passes through the filter in first order. An optical path connecting a surface opposite to a multilayer film of the filter in mth (m=1, . . . , M) order and the second collimator in (m+1)th order to each other passes through the filter in (m+1)th order. The filter in (m+1)th order is optically coupled on the surface opposite to the multilayer film to the filter in mth order and is optically coupled on a surface of the multilayer film to the second collimator in (m+1)th order.

### CROSS-REFERENCE TO RELATED APPLICATIONS

This application claims priority based on Japanese Patent Application No. 2021-108447 filed on Jun. 30, 2021, and the entire contents of which are incorporated herein by reference.

### TECHNICAL FIELD

The present disclosure relates to a wavelength multiplexing/demultiplexing device.

### BACKGROUND

Patent Document 1 (U.S. Pat. No. 6,515,776) discloses an optical device used in a wavelength division multiplex system. The optical device includes a fiber collimator and a plurality of fiber assemblies. The plurality of fiber assemblies are sequentially and optically coupled to the fiber collimator by reflected light paths of substantially parallel beams. The fiber collimator includes an optical fiber and a lens facing the optical fiber. Each of fiber assemblies includes an optical filter providing a reflected light path, an optical fiber optically coupled to the optical filter by the transmitted light path, and a lens disposed between the optical filter and the optical fiber. The lens of the fiber assembly in ith (i is an integer of 2 or more) order has a focal distance equal to or greater than that of the lens of the fiber assembly in (i−1)th order.

Patent Document 2 (U.S. Pat. No. 7,031,610) discloses a wavelength division multiplexer (WDM). This WDM uses a thin film filter as a concave mirror. The WDM includes a plurality of filter elements to guide an optical signal along a predetermined optical path. Each of filter elements is transparent in a predetermined wavelength range and includes compensation means for at least partially compensating diffraction of the optical signal. Each of filter elements is formed by coating a thin film on a substrate, and the compensation means is a curved surface of each thin film. (See also the following non-patent literature. Honda, et al. “Diffraction-compensated free-space WDM add-Drop module with thin-film filters”, IEEE Photonics Technology Letters, Vol. 15, No. 1, pp. 69-71 (2003))

### SUMMARY

A wavelength multiplexing/demultiplexing device according to an embodiment of the present disclosure includes a first collimator, an M number of second collimators, and the M number of first wavelength selective filters. M is an integer of 2 or more. The first collimator includes a first optical waveguide and a first collimator lens optically coupled to one end of the first optical waveguide. Each of the second collimators includes a second optical waveguide and a second collimator lens optically coupled to one end of the second optical waveguide. Each of the first wavelength selective filters includes a substrate that has a first surface and a second surface opposite to each other and that has a light transmission property, and a multilayer film that is provided on a first surface of the substrate. The M number of the first wavelength selective filters have transmission wavelength bands differing from each other and reflect light of wavelength bands except the transmission wavelength bands. An optical path connecting the first optical waveguide of the first collimator and the second optical waveguide of a second collimator in first order of the second collimators to each other passes through the first collimator lens, a first wavelength selective filter in first order of the first wavelength selective filters, and the second collimator lens of the second collimator in first order. The first wavelength selective filter in first order is optically coupled on the second surface of the substrate to the first collimator lens via the optical path and is optically coupled on the first surface of the substrate to the second collimator lens of the second collimator in first order via the optical path. An optical path connecting the second surface of the substrate of a first wavelength selective filter in mth (m=1, . . . , M−1) order of the first wavelength selective filters and the second optical waveguide of a second collimator in (m+1)th order of the second collimators to each other passes through the first wavelength selective filter in (m+1)th order and the second collimator lens of the second collimator in (m+1)th order. The first wavelength selective filter in (m+1)th order is optically coupled on the second surface of the substrate to the first wavelength selective filter in mth order via the optical path and is optically coupled on the first surface of the substrate to the second collimator lens of the second collimator in (m+1)th order via the optical path. In each of the second collimators, a focal distance of the second collimator lens and a distance between the second collimator lens and the one end of the second optical waveguide are set such that a working distance of each of the second collimators is negative.

### BRIEF DESCRIPTION OF THE DRAWINGS

FIG. 1 is a diagram schematically illustrating a configuration of a wavelength multiplexing/demultiplexing device according to an embodiment.

FIG. 2 is a cross-sectional view illustrating a configuration of a first collimator.

FIG. 3 is a cross-sectional view illustrating a configuration of a second collimator.

FIG. 4 is a cross-sectional view illustrating a configuration of a first wavelength selective filter.

FIG. 5 is a graph illustrating a transmission wavelength band of a multilayer film of each of first wavelength selective filters.

FIG. 6 is a diagram illustrating an operation of a wavelength multiplexing/demultiplexing device when an M number of optical signals having wavelengths differing from each other are multiplexed.

FIG. 7 is a diagram illustrating an operation of a wavelength multiplexing/demultiplexing device when an M number of optical signals having wavelengths differing from each other are demultiplexed.

FIG. 8 illustrates a relationship between a coupling loss and a distance between a wavelength selective filter and a collimator when light reflected from the wavelength selective filter suitable for DWDM at a 100 GHz interval is incident on the collimator.

FIG. 9 illustrates the a relationship between a coupling loss when a transmitted light from the same wavelength selective filter as that used for measurement in FIG. 8 is incident on the collimator, and a distance between the wavelength selective filter and the collimator

FIG. 10 is a graph illustrating a result of an examination of shift in a center wavelength of a transmitted light as an incident position of a beam on a wavelength selective filter suitable for DWDM at the 100 GHz interval is moved in one direction along a surface of a substrate.

FIG. 11 is a schematic diagram illustrating a state in which a beam is transmitted through a wavelength selective filter.

FIG. 12 is a schematic view illustrating a state in which a beam passes through a multilayer film having a more emphasized film thickness distribution.

FIG. 13 is a schematic view illustrating a state in which a certain beam is incident on a second surface of a wavelength selective filter and passes through a multilayer film in a spatially configured multiplexer/demultiplexer (MUX/DEMUX) module.

FIG. 14 is a graph illustrating a relationship among a working distance of a collimator, a beam diameter at a beam waist, and a focal distance inherent to a collimator lens when a distance between an optical fiber and the collimator lens is changed.

FIG. 15 is a diagram illustrating a configuration example for measuring a working distance and a beam diameter of a second collimator.

FIG. 16 is a graph illustrating a relationship between a propagation distance of light emitted from a second collimator and a beam diameter.

FIG. 17 is a diagram illustrating another configuration example for measuring a working distance and a beam diameter of a second collimator.

FIG. 18 is a graph illustrating a relationship between a distance from a second collimator to another collimator and a coupling loss therebetween when the second collimator and another collimator face each other.

FIG. 19 is a diagram illustrating a configuration of a wavelength multiplexing/demultiplexing device according to a first modification.

FIG. 20 is a graph illustrating a transmission wavelength band of each of first wavelength selective filters according to the first modification.

FIG. 21 is a diagram illustrating a configuration of a wavelength multiplexing/demultiplexing device according to a second modification.

FIG. 22 is a graph illustrating a transmission wavelength band of each of first wavelength selective filters according to the second modification.

FIG. 23 is a diagram illustrating a configuration of a wavelength multiplexing/demultiplexing device according to a third modification.

FIG. 24 is a cross-sectional view illustrating a configuration of a third collimator.

FIG. 25 is a graph illustrating transmission wavelength bands of each of first wavelength selective filters and each of second wavelength selective filters in the third modification.

FIG. 26 is a diagram illustrating a configuration of a wavelength multiplexing/demultiplexing device according to a fourth modification.

FIG. 27 is a diagram illustrating a configuration of a wavelength multiplexing/demultiplexing device according to a fifth modification.

FIG. 28 is a diagram schematically illustrating a configuration of a wavelength multiplexing/demultiplexing device as a comparative example.

### DETAILED DESCRIPTION

For example, a wavelength multiplexing/demultiplexing device is used in a wavelength multiplexing type optical communication system or the like. The wavelength multiplexing/demultiplexing device multiplexes a plurality of optical signals having wavelengths differing from each other into a wavelength multiplexed optical signal, or demultiplexes a wavelength multiplexed optical signal including a plurality of optical signals having wavelengths differing from each other into individual optical signals. Typically, the wavelength multiplexing/demultiplexing device includes a plurality of wavelength selective filters that transmit corresponding optical signals and reflect other optical signals. The plurality of wavelength selective filters are arranged in two rows such that positions of the wavelength selective filters in one row and positions of wavelength selective filters in the other row are different from each other in an array direction. For example, when a plurality of optical signals are multiplexed, each of optical signals is input to a corresponding wavelength selective filter through an optical waveguide and a collimator, and each of optical signals transmitted through the wavelength selective filter is multiplexed with another optical signal while being reflected by another wavelength selective filter. Alternatively, when a plurality of optical signals are demultiplexed, a wavelength multiplexed optical signal travels while being reflected by a plurality of wavelength selective filters, and each of optical signals is demultiplexed from the wavelength multiplexed optical signal by being transmitted through a corresponding wavelength selective filter and is output through a collimator and an optical waveguide.

In such a wavelength multiplexing/demultiplexing device, signal light emitted from or incident on a collimator propagates through space. Usually, the collimator and the wavelength selective filter are arranged at a distance from each other such that a beam waist is formed between the collimator and the wavelength selective filter, and between the wavelength selective filters themselves. Accordingly, such a wavelength multiplexing/demultiplexing device tends to become large in size, and a reduction in size of the wavelength multiplexing/demultiplexing device is required in order to miniaturize the optical communication system. Therefore, an object of the present disclosure is to provide a wavelength multiplexing/demultiplexing device that can be miniaturized.

According to the present disclosure, it is possible to provide a wavelength multiplexing/demultiplexing device that can be miniaturized.

### Description of Embodiments of the Present Disclosure

First, contents of embodiments according to the present disclosure will be listed and described. A wavelength multiplexing/demultiplexing device according to an embodiment includes a first collimator, an M number of second collimators, and the M number of first wavelength selective filters. M is an integer of 2 or more. The first collimator includes a first optical waveguide and a first collimator lens optically coupled to one end of the first optical waveguide. Each of the second collimators includes a second optical waveguide and a second collimator lens optically coupled to one end of the second optical waveguide. Each of the first wavelength selective filters includes a substrate that has a first surface and a second surface opposite to each other and that has a light transmission property, and a multilayer film that is provided on the first surface of the substrate. The M number of the first wavelength selective filters have transmission wavelength bands differing from each other and reflect light of wavelength bands except the transmission wavelength bands. An optical path that connects the first optical waveguide of the first collimator and the second optical waveguide of a second collimator in first order of the second collimators to each other passes through the first collimator lens, a first wavelength selective filter in first order of the first wavelength selective filters, and the second collimator lens of the second collimator in first order. The first wavelength selective filter in first order is optically coupled on the second surface of the substrate to the first collimator lens via the optical path and is optically coupled on the first surface of the substrate to the second collimator lens of the second collimator in first order via the optical path. An optical path that connects the second surface of the substrate of a first wavelength selective filter in mth (m=1, . . . , M−1) order of the first wavelength selective filters and the second optical waveguide of a second collimator in (m+1)th order of the second collimators to each other passes through the first wavelength selective filter in (m+1)th order and the second collimator lens of the second collimator in (m+1)th order. The first wavelength selective filter in (m+1)th order is optically coupled on the second surface of the substrate to the first wavelength selective filter in mth order via the optical path and is optically coupled on the first surface of the substrate to the second collimator lens of the second collimator in (m+1)th order via the optical path. In each of the second collimators, a focal distance of the second collimator lens and a distance between the second collimator lens and the one end of the second optical waveguide are set such that a working distance of each of the second collimators is negative.

The wavelength multiplexing/demultiplexing device operates as follows when the M number of optical signals having wavelengths differing from each other are multiplexed. First, an Mth optical signal reaches the first wavelength selective filter in Mth order from the second optical waveguide of the second collimator in Mth order through the second collimator lens. The Mth optical signal is transmitted through the first wavelength selective filter in Mth order to reach the first wavelength selective filter in (M−1)th order, and is reflected by the first wavelength selective filter in (M−1)th order. At the same time, a (M−1)th optical signal reaches the first wavelength selective filter in (M−1)th order from the second optical waveguide of the second collimator in (M−1)th order through the second collimator lens. The (M−1)th optical signal is transmitted through the first wavelength selective filter in (M−1)th order and is multiplexed with the Mth optical signal. The multiplexed light reaches the first wavelength selective filter in (M−2)th order and is reflected by the first wavelength selective filter in (M−2)th order. At the same time, a (M−2)th optical signal reaches the first wavelength selective filter in (M−2)th order from the second optical waveguide of the second collimator in (M−2)th order through the second collimator lens. The (M−2)th optical signal is transmitted through the first wavelength selective filter in (M−2)th order and is multiplexed with the multiplexed light including the Mth optical signal and the (M−1)th optical signal. Thereafter, each of the optical signals down to a first optical signal is sequentially multiplexed in the same manner to generate a wavelength multiplexed optical signal. The generated wavelength multiplexed optical signal reaches the first collimator from the first wavelength selective filter in first order, and is output to the outside of the wavelength multiplexing/demultiplexing device from the first optical waveguide of the first collimator.

The wavelength multiplexing/demultiplexing device operates as follows when the M number of optical signals having wavelengths differing from each other are demultiplexed. First, a wavelength multiplexed optical signal including the M number of optical signals reaches the first wavelength selective filter in first order from the first optical waveguide of the first collimator through the first collimator lens. A first optical signal is transmitted through the first wavelength selective filter in first order, and is output to the outside of the wavelength multiplexing/demultiplexing device through the second collimator lens and the second optical waveguide of the second collimator in first order. The wavelength multiplexed optical signal including the remaining optical signals is reflected by the first wavelength selective filter in first order and reaches the first wavelength selective filter in second order. A second optical signal is transmitted through the first wavelength selective filter in second order, and is output to the outside of the wavelength multiplexing/demultiplexing device through the second collimator lens and the second optical waveguide of the second collimator in second order. The wavelength multiplexed optical signal including the remaining optical signals is reflected by the first wavelength selective filter in second order and reaches the first wavelength selective filter in third order. Thereafter, each of the optical signals up to a Mth optical signal is sequentially demultiplexed in the same manner, and is output to the outside of the wavelength multiplexing/demultiplexing device.

In the wavelength multiplexing/demultiplexing device described above, each of the first wavelength selective filters includes a substrate and a multilayer film provided on a first surface of the substrate. When each of first wavelength selective filters is fabricated, the multilayer film is formed on the substrate at a certain deposition temperature, and then the substrate is cooled. At this time, due to a difference in thermal expansion coefficient between the multilayer film and the substrate, a warp is generated such that the first surface of the substrate and a surface of the multilayer film are convexly curved. Due to this warp, the first wavelength selective filters act as reflective concave lenses for light incident from the second surface of the substrate.

Therefore, in the wavelength multiplexing/demultiplexing device described above, the first wavelength selective filter in first order is optically coupled on the second surface of the substrate to the first collimator lens. The first wavelength selective filter in (m+1)th order is optically coupled on the second surface of the substrate to the first wavelength selective filter in mth order. Therefore, even when the number of optical signals included in the wavelength multiplexed optical signal increases, it is possible to suppress a spread of beam diameters of the optical signals propagating between the first wavelength selective filters by effectively using the concave lenses described above.

In the wavelength multiplexing/demultiplexing device described above, each of the first wavelength selective filters is optically coupled on the first surface of the substrate to the second collimator lens of the corresponding second collimator. According to the findings of the present inventors, an actual lens power of a lens effect on transmitted light of the multilayer film due to the difference in thermal expansion coefficient between the substrate and the multilayer film is larger than a theoretical lens power derived from a curvature of the multilayer film surface. Therefore, a distance between each of the first wavelength selective filters and a corresponding second collimator lens may be set such that a beam waist is formed between each of the first wavelength selective filter and the corresponding second collimator lens. However, in such a distance setting, an optical path between the first wavelength selective filter and the second collimator becomes long. This hinders miniaturization of the wavelength multiplexing/demultiplexing device. In the wavelength multiplexing/demultiplexing device described above, in each of the second collimators, a focal distance of the second collimator lens and a distance between the second collimator lens and one end of the second optical waveguide are set such that a working distance of the second collimator is negative. In other words, each of second collimators has a configuration to efficiently couple the second collimator lens and the second optical waveguide while emitting diffused light from the second collimator lens (or while receiving converging light to the second collimator lens). Accordingly, it is not necessary to form a beam waist between the first wavelength selective filter and the second collimator lens, and an optical path between the first wavelength selective filter and the second collimator can be shortened. Therefore, the wavelength multiplexing/demultiplexing device can be miniaturized.

In the wavelength multiplexing/demultiplexing device, the focal distance of the second collimator lens of each of the M number of the second collimators may be shorter than a focal distance of the first collimator lens.

In the wavelength multiplexing/demultiplexing device, the focal distance of the second collimator lens of each of the M number of the second collimators may be included in a range of ±5% from a predetermined focal distance. According to the wavelength multiplexing/demultiplexing device described above, since a spread of beam diameters of the optical signals propagating between the first wavelength selective filters can be suppressed, the focal distance of the second collimator lens can be made substantially equal to each other in the M number of the second collimators. Therefore, the same second collimator lens can be used as the M number of the second collimator lenses, and the number of components of the wavelength multiplexing/demultiplexing device can be reduced.

In the wavelength multiplexing/demultiplexing device, an interval of center wavelengths of the transmission wavelength bands between the M number of the first wavelength selective filters may be 50 GHz or more, or 100 GHz or more in terms of frequency. According to the wavelength multiplexing/demultiplexing device described above, it is possible to provide a wavelength multiplexing/demultiplexing device suitable for multiplexing or demultiplexing a wavelength multiplexed optical signal having such a narrow wavelength interval.

In the above wavelength multiplexing/demultiplexing device, transmission wavelength bandwidths of the M number of the first wavelength selective filters may be equal to each other. Alternatively, in the above wavelength multiplexing/demultiplexing device, a transmission wavelength bandwidth of at least one of the first wavelength selective filter may differ from a transmission wavelength bandwidth of each of others of the first wavelength selective filters. According to the above-described wavelength multiplexing/demultiplexing device, it is possible to miniaturize such various types of wavelength multiplexing/demultiplexing devices.

The wavelength multiplexing/demultiplexing device may further include an N number (N is an integer of 2 or more) of third collimators, the N number of second wavelength selective filters, and a third wavelength selective filter. Each of the third collimators includes a third optical waveguide and a third collimator lens optically coupled to one end of the third optical waveguide. Each of the second wavelength selective filters includes a substrate that has a first surface and a second surface opposite to each other and that has a light transmission property, and a multilayer film that is provided on the first surface of the substrate. The N number of the second wavelength selective filters have transmission wavelength bands that differ from each other and that differ from the transmission wavelength bands of the M number of the first wavelength selective filters. The second wavelength selective filters reflect light of wavelength bands except the transmission wavelength bands. The third wavelength selective filter includes a substrate that has a first surface and a second surface opposite to each other and that has a light transmission property, and a multilayer film that is provided on the first surface of the substrate. The third wavelength selective filter has a transmission wavelength band including all of the transmission wavelength bands of the M number of the first wavelength selective filters and not including any one of the transmission wavelength bands of the N number of the second wavelength selective filters. The third wavelength selective filter reflects light of wavelength bands except the transmission wavelength band. An optical path that connects the first optical waveguide of the first collimator and the third optical waveguide of a third collimator in first order of the third collimators to each other further passes through the third wavelength selective filter. The third wavelength selective filter is optically coupled on the second surface of the substrate to the first collimator lens via the optical path, and is optically coupled on the first surface of the substrate to the first wavelength selective filter in first order via the optical path. An optical path that connects the second surface of the substrate of the third wavelength selective filter and the third optical waveguide of the third collimator in first order to each other passes through a second wavelength selective filter in first order of the second wavelength selective filters and the third collimator lens of the third collimator in first order. The second wavelength selective filter in first order is optically coupled on the second surface of the substrate to the third wavelength selective filter via the optical path, and is optically coupled on the first surface of the substrate to the third collimator lens of the third collimator in first order via the optical path. An optical path that connects the second surface of the substrate of a second wavelength selective filter in nth (n=1, . . . , N−1) order of the second wavelength selective filters and the third optical waveguide of a third collimator in (n+1)th order of the third collimators to each other passes through a second wavelength selective filter in (n+1)th order of the second wavelength selective filters and the third collimator lens of the third collimator in (n+1)th order. The second wavelength selective filter in (n+1)th order is optically coupled on the second surface of the substrate to the second wavelength selective filter in nth order via the optical path, and is optically coupled on the first surface side of the substrate to the third collimator lens of the third collimator in (n+1)th order via the optical path. In each of the third collimators, a focal distance of the third collimator lens and a distance between the third collimator lens and the one end of the third optical waveguide are set such that a working distance of each of the third collimators is negative.

In the wavelength multiplexing/demultiplexing device, the N number of the third collimators and the N number of the second wavelength selective filters have the same arrangements and characteristics as those of the M number of the second collimators and the M number of the first wavelength selective filters described above. Therefore, when a (M+N) number of optical signals having wavelengths differing from each other are multiplexed, a wavelength multiplexed optical signal including the M number of the optical signals is multiplexed by the M number of the second collimators and the M number of the first wavelength selective filters, and a wavelength multiplexed optical signal including the N number of the optical signals is multiplexed by the N number of the third collimators and the N number of the second wavelength selective filters. Subsequently, the wavelength multiplexed optical signal including the M number of the optical signals and the wavelength multiplexed optical signal including the N number of the optical signals are multiplexed with each other by the third wavelength selective filter to be output from the first collimator to the outside of the wavelength multiplexing/demultiplexing device. In addition, when the (M+N) number of the optical signals having wavelengths differing from each other are demultiplexed, a wavelength multiplexed optical signal including these optical signals reaches the third wavelength selective filter from the first collimator, and is demultiplexed into a wavelength multiplexed optical signal including the M number of the optical signals having wavelengths differing from each other and a wavelength multiplexed optical signal including the N number of the optical signals having wavelengths differing from each other by the third wavelength selective filter. Thereafter, the wavelength multiplexed optical signal including the M number of the optical signals is demultiplexed into individual optical signals by the M number of the second collimators and the M number of the first wavelength selective filters. Also, the wavelength multiplexed optical signal including the N number of the optical signals is demultiplexed into individual optical signals by the N number of the third collimators and the N number of the second wavelength selective filters.

Also in each of the second wavelength selective filters, a warp is generated such that the first surface of the substrate and the surface of the multilayer film are convexly curved. Due to this warp, the second wavelength selective filters act as reflective concave lenses for light incident from the side of the second surface of the substrate. Therefore, in this wavelength multiplexing/demultiplexing device, the second wavelength selective filter in first order is optically coupled on the second surface of the substrate to the third wavelength selective filter. The second wavelength selective filter in (n+1)th order is optically coupled on the second surface of the substrate to the second wavelength selective filter in nth order. Therefore, even when the number of optical signals included in the wavelength multiplexed optical signal increases, it is possible to suppress a spread of beam diameters of optical signals propagating between the second wavelength selective filters by effectively using the concave lenses described above.

In the wavelength multiplexing/demultiplexing device, each of the second wavelength selective filters is optically coupled on the first surface of the substrate to the third collimator lens of the corresponding third collimator. In each of the third collimators, a focal distance of the third collimator lens and a distance between the third collimator lens and one end of the third optical waveguide are set such that a working distance of the third collimator is negative. Accordingly, it is not necessary to form a beam waist between each of the second wavelength selective filters and a corresponding third collimator lens, and an optical path between each of the second wavelength selective filter and a corresponding third collimator of the third collimators can be shortened. Therefore, the wavelength multiplexing/demultiplexing device can be miniaturized.

The wavelength multiplexing/demultiplexing device may further include a fourth collimator that is optically coupled to the second surface of the substrate of a first wavelength selective filter in Mth order of the first wavelength selective filters. In this case, it is possible to miniaturize a wavelength multiplexing/demultiplexing device having a port for upgrading.

In the above wavelength multiplexing/demultiplexing device, the second collimator lens may be a C lens. In this case, the second collimators having negative working distances can be realized by using general-purpose collimators.

In the above wavelength multiplexing/demultiplexing device, a surface of the second collimator lens facing the one end of the second optical waveguide may be inclined with respect to an imaginary plane perpendicular to an optical axis of the second optical waveguide. In this case, reflection return light inside the second collimators can be reduced.

### Details of Embodiments of the Present Disclosure

Specific examples of wavelength multiplexing/demultiplexing device according to the present disclosure will be described below with reference to the drawings. It should be noted that the present invention is not limited to these examples, but is defined by the scope of claims and intended to include all modifications within the meaning and scope equivalent to the scope of claims. In the following description, like elements are denoted by like reference numerals in the description of the drawings, and redundant descriptions thereof will be omitted.

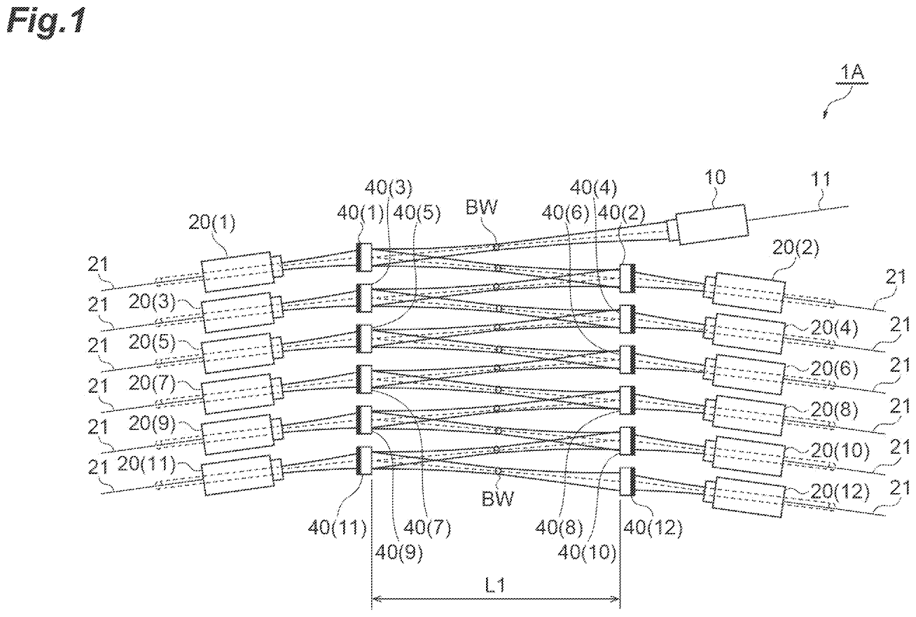

FIG. 1 is a diagram schematically illustrating a configuration of a wavelength multiplexing/demultiplexing device 1A according to an embodiment of the present disclosure. Wavelength multiplexing/demultiplexing device 1A is a MUX/DEMUX module used in an optical communication system, and generates a wavelength multiplexed optical signal by multiplexing a M number of optical signals having wavelengths differing from each other, or demultiplexes a wavelength multiplexed optical signal including the M number of the optical signals having wavelengths differing from each other into individual optical signals. As illustrated in FIG. 1, wavelength multiplexing/demultiplexing device 1A includes a first collimator 10, the M number of second collimators 20 (1) to 20 (M), and the M number of first wavelength selective filters 40 (1) to 40 (M). M is an integer of 2 or more. FIG. 1 illustrates an example where M=12.

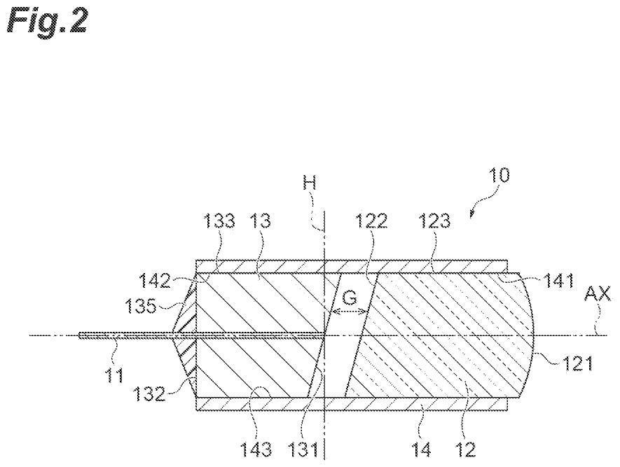

FIG. 2 is a cross-sectional view illustrating a configuration of first collimator 10. First collimator 10 includes an optical fiber 11 (first optical waveguide), a first collimator lens 12, a ferrule 13, and a capillary 14.

Optical fiber 11 is, for example, a single-mode optical fiber made of glass. Optical fiber 11 has a core that extends in an optical waveguiding direction and a clad that covers a periphery of the core. Ferrule 13 is a columnar member, and has a first end surface 131, a second end surface 132, and an outer peripheral surface 133. First end surface 131 and second end surface 132 intersect a central axis of ferrule 13. Outer peripheral surface 133 is a columnar surface that connects first end surface 131 and second end surface 132 to each other. Ferrule 13 is attached to a tip of optical fiber 11. A through hole is formed in ferrule 13 along the central axis of ferrule 13. Optical fiber 11 is inserted into the through hole of ferrule 13. The central axis of ferrule 13 coincides with an optical axis AX of optical fiber 11. An end face of optical fiber 11 is exposed at first end surface 131, and is polished together with first end surface 131 to be flush with first end surface 131. The end face of optical fiber 11 and first end surface 131 are inclined with respect to an imaginary plane H perpendicular to optical axis AX of optical fiber 11. An inclination angle of first end surface 131 with respect to imaginary plane H is from 6° to 10°, and is, for example, 8°. Second end surface 132 is provided with a resin adhesive 135 for fixing optical fiber 11 to ferrule 13. Ferrule 13 can be made of, for example, glass such as quartz, or ceramic such as zirconia.

First collimator lens 12 is a columnar lens component. First collimator lens 12 can be made of a material such as quartz, or optical glass tailored for optical components. First collimator lens 12 has a first end surface 121, a second end surface 122, and an outer peripheral surface 123. First end surface 121 and second end surface 122 intersect a central axis of first collimator lens 12. Outer peripheral surface 123 connects first end surface 121 and second end surface 122 to each other. First end surface 121 is a spherical surface and functions as a convex lens. A focal distance of first collimator lens 12 is, for example, from 1.6 mm to 3.2 mm, and is 2.7 mm in one example. Second end surface 122 faces one end face of optical fiber 11 and is optically coupled to the one end face. First collimator lens 12 is referred to as a C lens. Second end surface 122 of first collimator lens 12 is inclined with respect to imaginary plane H. An inclination angle of second end surface 122 with respect to imaginary plane H is from 6° to 10°, and is, for example, 8°. In one example, second end surface 122 is parallel to first end surface 131 of ferrule 13.

Capillary 14 is a cylindrical member that houses first collimator lens 12 and ferrule 13. Capillary 14 can be made of, for example, glass such as quartz, or metal such as SUS. First collimator lens 12 is inserted from a first opening 141 of capillary 14. Ferrule 13 is inserted from a second opening 142 of capillary 14. Outer peripheral surface 123 of first collimator lens 12 and outer peripheral surface 133 of ferrule 13 are in contact with an inner peripheral surface 143 of capillary 14. The end face of optical fiber 11 and second end surface 122 of first collimator lens 12 face each other in an inner space of capillary 14. Capillary 14 holds first collimator lens 12 and ferrule 13 such that optical axis AX of optical fiber 11 and the central axis of first collimator lens 12 coincide with each other.

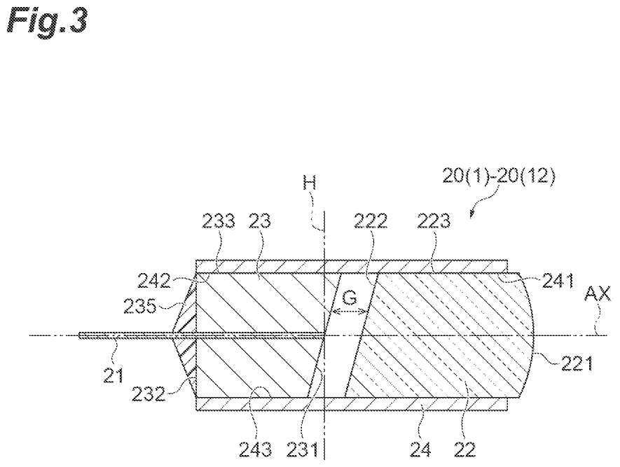

FIG. 3 is a cross-sectional view illustrating a configuration of each of second collimators 20 (1) to 20 (M). Second collimators 20 (1) to 20 (M) have the same configurations as that of first collimator 10 described above. Second collimators 20 (1) to 20 (M) each include an optical fiber 21 (second optical waveguide), a second collimator lens 22, a ferrule 23, and a capillary 24.

Optical fiber 21 has the same configuration as that of optical fiber 11 described above. Ferrule 23 is a columnar member, and has a first end surface 231, a second end surface 232, and an outer peripheral surface 233. First end surface 231 and second end surface 232 are flat and intersect a central axis of ferrule 23. Outer peripheral surface 233 is a columnar surface that connects first end surface 231 and second end surface 232 to each other. Ferrule 23 is attached to a tip of optical fiber 21. A through hole is formed in ferrule 23 along the central axis of ferrule 23. Optical fiber 21 is inserted into the through hole of ferrule 23. The central axis of ferrule 23 coincides with an optical axis AX of optical fiber 21. An end face of optical fiber 21 is exposed at first end surface 231, and is polished together with first end surface 231 to be flush with first end surface 231. The end face of optical fiber 21 and first end surface 231 are inclined with respect to an imaginary plane H perpendicular to optical axis AX of optical fiber 21. An inclination angle of first end surface 231 with respect to imaginary plane H is from 6° to 10°, and is, for example, 8°. Second end surface 232 is provided with a resin adhesive 235 for fixing optical fiber 21 to ferrule 23. Ferrule 23 can be made of, for example, glass such as quartz, or ceramic such as zirconia.

Second collimator lens 22 is a columnar lens component. Second collimator lens 22 can be made of a material such as quartz, or optical glass tailored for optical components. Second collimator lens 22 has a first end surface 221, a second end surface 222, and an outer peripheral surface 223. First end surface 221 and second end surface 222 intersect a central axis of second collimator lens 22. Outer peripheral surface 223 is a columnar surface that connects first end surface 221 and second end surface 222 to each other. First end surface 221 is a spherical surface and functions as a convex lens. A focal distance of second collimator lens 22 is, for example, from 1.6 mm to 3.2 mm, and is 2.4 mm in one example. Thus, the focal distance of second collimator lens 22 is shorter than the focal distance of first collimator lens 12. Second end surface 222 is flat, and faces one end face of optical fiber 21 with a distance G therebetween to be optically coupled to the one end face. Second collimator lens 22 is referred to as a C lens. Second end surface 222 of second collimator lens 22 is inclined with respect to imaginary plane H. An inclination angle of second end surface 222 with respect to imaginary plane H is from 6° to 10°, and is, for example, 8°. In one example, second end surface 222 is parallel to first end surface 231 of ferrule 23.

Capillary 24 is a cylindrical member that houses second collimator lens 22 and ferrule 23. Capillary 24 can be made of, for example, glass such as quartz, or metal such as SUS. Second collimator lens 22 is inserted from a first opening 241 of capillary 24. Ferrule 23 is inserted from a second opening 242 of capillary 24. Outer peripheral surface 223 of second collimator lens 22 and outer peripheral surface 233 of ferrule 23 are in contact with inner peripheral surface 243 of capillary 24. The end face of optical fiber 21 and second end surface 222 of second collimator lens 22 face each other in an inner space of capillary 24. Capillary 24 holds second collimator lens 22 and ferrule 23 such that optical axis AX of optical fiber 21 and the central axis of second collimator lens 22 coincide with each other.

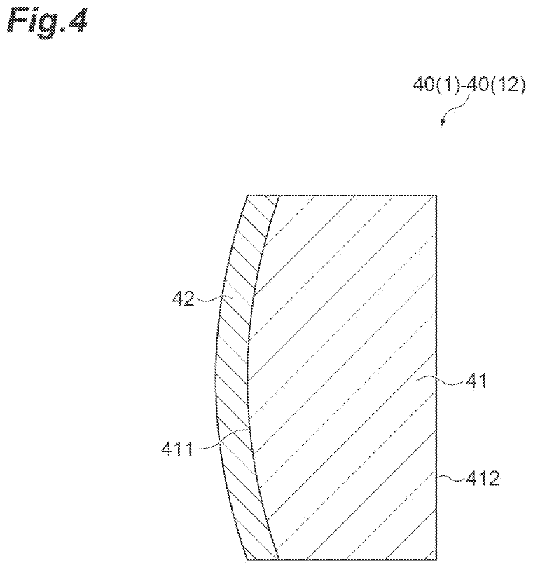

FIG. 4 is a cross-sectional view illustrating a configuration of each of first wavelength selective filters 40 (1) to 40 (M). First wavelength selective filters 40 (1) to 40 (M) each include a substrate 41 and a multilayer film 42. Substrate 41 is made of a material having a light transmission property, and is made of glass in one example. Here, “having a light transmission property” means having a light transmission property in a wavelength band that includes all wavelengths included in a wavelength multiplexed optical signal. Furthermore, “having a light transmission property” means transmitting 95% or more of light having a target wavelength. A refractive index of substrate 41 is, for example, 1.5. Substrate 41 has a first surface 411 and a second surface 412 that face to opposite directions to each other.

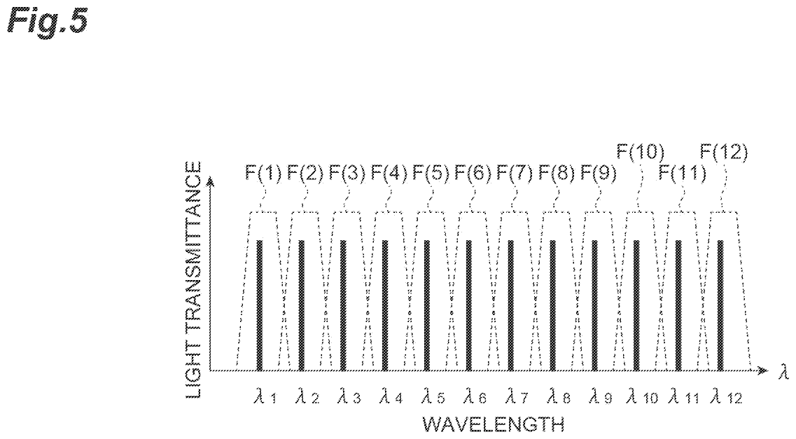

Multilayer film 42 is a thin film filter (TFF). Multilayer film 42 is provided on first surface 411 of substrate 41 and is in contact with first surface 411. Multilayer film 42 is formed by alternately laminating two types of dielectrics having different refractive indices, such as SiO₂ and Ta₂O₅. Multilayer film 42 is a bandpass filter that transmits light of a specific transmission wavelength band and reflects light of a wavelength band except the transmission wavelength band. FIG. 5 is a graph illustrating a transmission wavelength band of multilayer film 42 of each of first wavelength selective filters 40 (1) to 40 (M). In FIG. 5, a horizontal axis represents a wavelength, and a vertical axis represents a light transmittance. In the figure, transmission wavelength bands F (1) to F (M) each corresponding to first wavelength selective filters 40 (1) to 40 (M) are illustrated. In FIG. 5, signal wavelengths λ₁ to λ_{M} of optical signals are also illustrated. As illustrated in FIG. 5, multilayer film 42 has different transmission wavelength bands F (1) to F (M) in each of first wavelength selective filters 40 (1) to 40 (M). In the present specification, the term “different transmission wavelength band” mainly means that a center wavelength of the transmission wavelength band is different, and it is allowed for the transmission wavelength band to overlap with adjacent transmission wavelength bands near a short wavelength end and near a long wavelength end in the transmission wavelength band. In the present embodiment, widths of transmission wavelength bands F (1) to F (M) are equal to each other. Transmission wavelength bands F (1) to F (M) include signal wavelengths λ₁ to λ_{M}, respectively. In one example, each of signal wavelengths λ₁ to λ_{M} is a center wavelength of respective transmission wavelength bands F (1) to F (M).

In first wavelength selective filters 40 (1) to 40 (M), substrate 41 having a large thermal expansion coefficient is used to suppress a variation of the transmission wavelength band due to a temperature change to be small. When each of first wavelength selective filters 40 (1) to 40 (M) is fabricated, multilayer film 42 is formed on substrate 41 at a certain deposition temperature, and then substrate 41 is cooled. At this time, due to a difference in thermal expansion coefficient between multilayer film 42 and substrate 41, a warp tends to be generated such that first surface 411 of substrate 41 and the surface of multilayer film 42 are convexly curved. In particular, multilayer film 42 suitable for a DWDM (Dense-WDM) signal having a narrow wavelength interval is formed by laminating 100 or more layers to obtain a steep transmission characteristic. In this case, a radius of curvature of the surface of multilayer film 42 has a small value such as 1.4 m. Due to this warp, first wavelength selective filters 40 (1) to 40 (M) act as reflective concave lenses for light incident from second surface 412 of substrate 41.

With reference to FIG. 1 again, first wavelength selective filters 40 (1) to 40 (M) are arranged in two rows of a first row and a second row, and are arranged such that the positions of the first wavelength selective filters in an array direction are made alternate between the first row and the second row. Specifically, first wavelength selective filters 40 (1), 40 (3), 40 (5), . . . , 40 (M−1) in odd-numbered order are arranged in a row in this order to form the first row. First wavelength selective filters 40 (2), 40 (4), 40 (6), . . . , 40 (M) in even-numbered order are arranged in a row in this order to form the second row. These rows are arranged in the same direction. In the array direction of these rows, first wavelength selective filter 40 (2) is located between first wavelength selective filter 40 (1) and first wavelength selective filter 40 (3). The same applies to the subsequent first wavelength selective filters 40 (3) to 40 (M−1). That is, in the array direction of these rows, first wavelength selective filter 40 (m) in mth (m=2, . . . , M−1) order is located between first wavelength selective filter 40 (m−1) and first wavelength selective filter 40 (m+1). Second surface 412 of substrate 41 of each of first wavelength selective filters 40 (1), 40 (3), 40 (5), . . . , 40 (M−1) in the first row is oriented toward the second row. Second surface 412 of substrate 41 of each of first wavelength selective filters 40 (2), 40 (4), 40 (6), . . . , 40 (M) in the second row is oriented toward the first row. An interval L1 between first wavelength selective filters 40 (1), 40 (3), 40 (5), . . . , 40 (M−1) in the first row and first wavelength selective filters 40 (2), 40 (4), 40 (6), . . . , 40 (M) in the second row is, for example, 32 mm.

First collimator 10, second collimators 20 (1) to 20 (M), and first wavelength selective filters 40 (1) to 40 (M) are arranged as follows. First collimator 10 is optically coupled linearly and spatially to second collimator 20 (1) in first order through first wavelength selective filter 40 (1) in first order. That is, an optical path that connects optical fiber 11 of first collimator 10 (see FIG. 2) and optical fiber 21 of second collimator 20 (1) (see FIG. 3) to each other passes through first collimator lens 12, first wavelength selective filter 40 (1), and second collimator lens 22 of second collimator 20 (1). First wavelength selective filter 40 (1) is optically coupled on second surface 412 of substrate 41 to first collimator lens 12 via the optical path. First wavelength selective filter 40 (1) is optically coupled on first surface 411 of substrate 41 to second collimator lens 22 of second collimator 20 (1) via the optical path.

Further, second surface 412 of substrate 41 of first wavelength selective filter 40 (1) is optically coupled linearly and spatially to second collimator 20 (2) in second order through first wavelength selective filter 40 (2) in second order. That is, an optical path that connects second surface 412 of substrate 41 of first wavelength selective filter 40 (1) and optical fiber 21 of second collimator 20 (2) to each other passes through first wavelength selective filter 40 (2) and second collimator lens 22 of second collimator 20 (2). First wavelength selective filter 40 (2) is optically coupled on second surface 412 of substrate 41 to first wavelength selective filter 40 (1) via the optical path. First wavelength selective filter 40 (2) is optically coupled on first surface 411 of substrate 41 to second collimator lens 22 of second collimator 20 (2) via the optical path. Second collimators 20 (3) to 20 (M) in third and more order and first wavelength selective filters 40 (3) to 40 (M) in third and more order are also arranged in the same manner.

In other words, the above configuration is as follows. Second surface 412 of substrate 41 of first wavelength selective filter 40 (m) in mth (m=1, . . . , M−1) order is optically coupled linearly and spatially to second collimator 20 (m+1) in (in +1)th order through first wavelength selective filter 40 (m+1) in (m+1)th order. That is, an optical path that connects 10 second surface 412 of substrate 41 of first wavelength selective filter 40 (m) and optical fiber 21 of second collimator 20 (m+1) to each other passes through first wavelength selective filter 40 (m+1) and second collimator lens 22 of second collimator 20 (m+1). First wavelength selective filter 40 (m+1) is optically coupled on second surface 412 of substrate 41 to first wavelength selective filter 40 (m) via the optical path. First wavelength selective filter 40 (m+1) is optically coupled on first surface 411 of substrate 41 to second collimator lens 22 of second collimator 20 (m+1) via the optical path.

A distance between first collimator lens 12 of first collimator 10 and first wavelength selective filter 40 (1) is set such that a beam waist BW is formed therebetween. Therefore, in first collimator 10, a focal distance of first collimator lens 12 and a distance between first collimator lens 12 and one end of optical fiber 11 are set such that a working distance of first collimator 10 is positive. A distance between first collimator lens 12 and first wavelength selective filter 40 (1) is, for example, 42 mm. A distance between first wavelength selective filter 40 (m) and first wavelength selective filter 40 (in +1) is also set such that a beam waist BW is formed therebetween. However, a distance between second collimator lens 22 of second collimator 20 (m) and first wavelength selective filter 40 (m) is set such that no beam waist BW is formed therebetween. Therefore, in each of second collimators 20 (1) to 20 (M), a focal distance of second collimator lens 22 and a distance G between second collimator lens 22 and one end of optical fiber 21 are set such that a working distance of second collimator 20 (m) is negative. Here, the term “working distance” represents a position of a beam waist when a beam emission direction of a collimator is in a positive direction and a collimator emission end is at the origin. When “a working distance is negative”, the working distance represents a position of an effective beam waist obtained by extrapolation based on the above position dependence of a beam diameter.

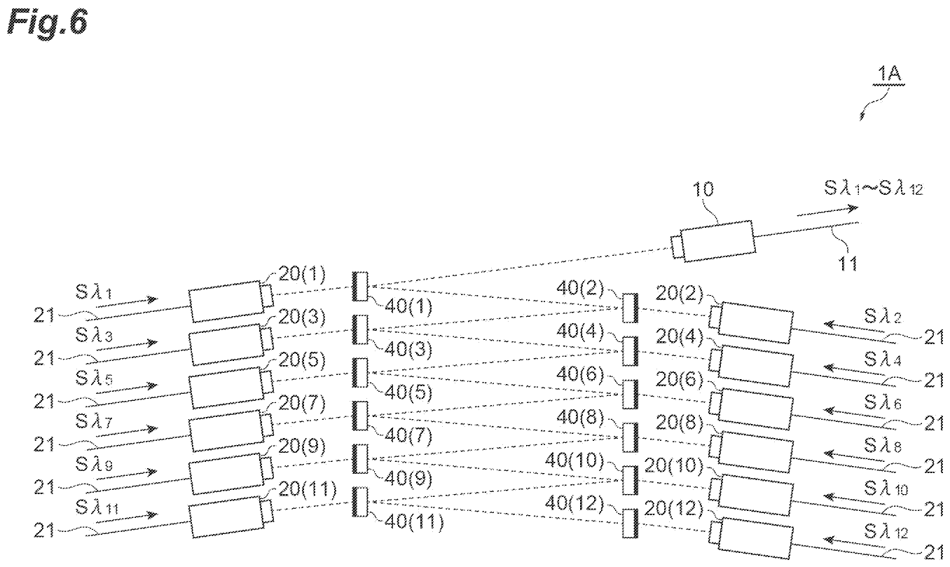

FIG. 6 is a diagram illustrating an operation of wavelength multiplexing/demultiplexing device 1A according to the present embodiment when an M number of optical signals Sλ₁ to Sλ_{M} having wavelengths differing from each other are multiplexed. In this case, first, an Mth optical signal Sλ_{M} reaches first wavelength selective filter 40 (M) in Mth order from optical fiber 21 of second collimator 20 (M) in Mth order through second collimator lens 22. Optical signal Sλ_{M} is transmitted through first wavelength selective filter 40 (M) to reach first wavelength selective filter 40 (M−1) in (M−1)th order, and is reflected by first wavelength selective filter 40 (M−1). At the same time, a (M−1)th optical signal Sλ_{M-1} reaches first wavelength selective filter 40 (M−1) from optical fiber 21 of second collimator 20 (M−1) in (M−1)th order through second collimator lens 22. Optical signal Sλ_{M-1} is transmitted through first wavelength selective filter 40 (M−1) and is multiplexed with optical signal Sλ_{M}. This multiplexed light reaches first wavelength selective filter 40 (M−2) in (M−2)th order and is reflected by first wavelength selective filter 40 (M−2). At the same time, a (M−2)th optical signal Sλ_{M-2} reaches first wavelength selective filter 40 (M−2) from optical fiber 21 of second collimator 20 (M−2) in (M−2)th order through second collimator lens 22. Optical signal Sλ_{M-2} is transmitted through first wavelength selective filter 40 (M−2) and is multiplexed with the multiplexed light including optical signals Sλ_{M} and Sλ_{M-1}. Thereafter, each of optical signals Sλ_{M-3} to Sλ₁ is sequentially multiplexed in the same manner to generate a wavelength multiplexed optical signal. The generated wavelength multiplexed optical signal reaches first collimator 10 from first wavelength selective filter 40 (1), and is output to the outside of wavelength multiplexing/demultiplexing device 1A from optical fiber 11 of first collimator 10.

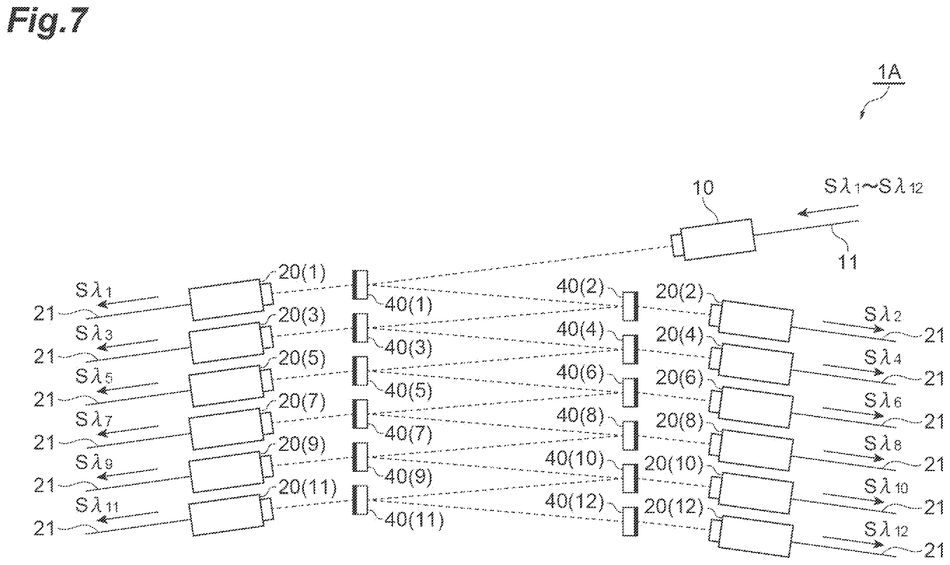

FIG. 7 is a diagram illustrating an operation of wavelength multiplexing/demultiplexing device 1A according to the present embodiment when the M number of optical signals Sλ₁ to Sλ_{M} having wavelengths differing from each other are demultiplexed. In this case, first, a wavelength multiplexed optical signal including optical signals Sλ₁ to Sλ_{M} reaches first wavelength selective filter 40 (1) from optical fiber 11 of first collimator 10 through first collimator lens 12. A first optical signal Sλ₁ is transmitted through first wavelength selective filter 40 (1) and is output to the outside of wavelength multiplexing/demultiplexing device 1A through second collimator lens 22 and optical fiber 21 of second collimator 20 (1). The remaining optical signals Sλ₂ to Sλ_{M} are reflected by first wavelength selective filter 40 (1) and reach first wavelength selective filter 40 (2). A second optical signal Sλ₂ is transmitted through first wavelength selective filter 40 (2) and is output to the outside of wavelength multiplexing/demultiplexing device 1A through second collimator lens 22 and optical fiber 21 of second collimator 20 (2). The remaining optical signals Sλ₃ to Sλ_{M} are reflected by first wavelength selective filter 40 (2) and reach first wavelength selective filter 40 (3) in third order. Thereafter, each of optical signals Sλ₃ to Sλ_{M} is sequentially demultiplexed in the same manner, and is output to the outside of wavelength multiplexing/demultiplexing device 1A.

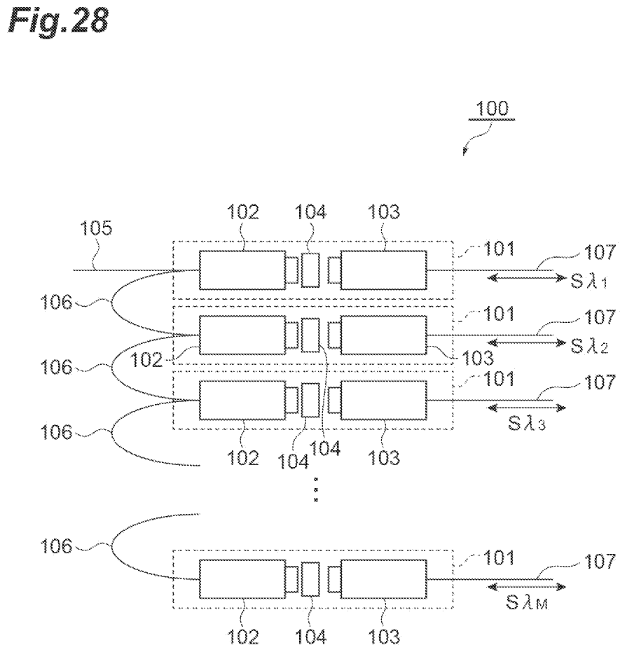

Advantageous effects obtained by wavelength multiplexing/demultiplexing device 1A according to the present embodiment described above will be described in comparison to a conventional wavelength multiplexing/demultiplexing device. In recent years, in the field of optical communications, there has been a demand to further increase a communication speed, and it is desirable to reduce a loss of each component constituting an optical communication system. In addition, cost reduction by reducing the number of components is also an important issue. FIG. 28 is a diagram schematically illustrating a configuration of a wavelength multiplexing/demultiplexing device 100 as a comparative example. A wavelength multiplexing/demultiplexing device 100 includes an M number of 1×2 modules 101 which are equal in number to optical signals Sλ₁ to Sλ_{M}. Each of 1×2 modules 101 includes a double-core collimator 102, a single-core collimator 103, and a wavelength selective filter 104. Double-core collimator 102 includes a collimator lens (not illustrated) and two input/output ports that are optically coupled to one side of the collimator lens. One input/output port of double-core collimator 102 in first order is coupled to the outside of wavelength multiplexing/demultiplexing device 100 through an optical fiber 105. The other input/output port of double-core collimator 102 in first order is coupled to one input/output port of double-core collimator 102 in second order through an optical fiber 106. Thereafter, the other input/output port of double-core collimator 102 in mth order is coupled to one input/output port of double-core collimator 102 in (m+1)th order through optical fiber 106.

Single-core collimator 103 includes an optical fiber 107 and a collimator lens (not illustrated) that is optically coupled to one end of optical fiber 107. Each single-core collimator 103 is disposed so as to face a corresponding double-core collimator 102. The collimator lens of single-core collimator 103 is optically coupled to the collimator lens of the corresponding double-core collimator 102. Wavelength selective filter 104 is disposed between single-core collimator 103 and double-core collimator 102. Wavelength selective filter 104 includes a substrate and a multilayer film as a thin film filter formed on the substrate. The M number of wavelength selective filters 104 have transmission wavelength bands differing from each other and reflect light having a wavelength band except the transmission wavelength bands. The transmission wavelength band of each of the M number of wavelength selective filters 104 includes a wavelength of a corresponding optical signal of optical signals Sλ₁ to Sλ_{M}.

In wavelength multiplexing/demultiplexing device 100, optical signals Sλ₁ to Sλ_{M} having wavelengths differing from each other are input from the M number of optical fibers 107, respectively. Optical signal Sλ_{M} and optical signal Sλ_{M-1} are multiplexed by wavelength selective filter 104 in (M−1)th order. The multiplexed light including optical signals Sλ_{M} and Sλ_{M-1}, is multiplexed with optical signal Sλ_{M-2} by wavelength selective filter 104 in (M−2)th order. Thereafter, each of optical signals Sλ_{M-3} to Sλ₁ is sequentially multiplexed by respective wavelength selective filters 104. Then, a wavelength multiplexed optical signal including optical signals Sλ₁ to Sλ_{M} is output from optical fiber 105.

Further, in wavelength multiplexing/demultiplexing device 100, a wavelength multiplexed optical signal including optical signals Sλ₁ to Sλ_{M} having wavelengths differing from each other is input from optical fiber 105. Optical signal Sλ₁ is demultiplexed from the wavelength multiplexed optical signal by wavelength selective filter 104 in first order. Optical signal Sλ₂ is further demultiplexed in wavelength selective filter 104 in second order. Thereafter each of optical signals Sλ₃ to Sλ_{M} is sequentially demultiplexed by respective wavelength selective filters 104. Each of the demultiplexed optical signals Sλ₁ to Sλ_{M} is output from a corresponding optical fiber of optical fibers 107.

In wavelength multiplexing/demultiplexing device 100, for example, optical signal Sλ_{M} needs to pass through the M number of double-core collimators 102 to be multiplexed or demultiplexed, and optical signal Sλ_{M-1} needs to pass through the (M−1) number of double-core collimators 102. As described above, the number of times an optical signal passes through double-core collimators 102 increases, depending on a wavelength of the optical signal. Therefore, coupling loss at optical fiber ends is generated by the number of times the optical signal passes through the collimator 102. Therefore, according to wavelength multiplexing/demultiplexing device 100, it is difficult to suppress the loss in at least one optical signal of optical signals Sλ₁ to Sλ_{M}.

In wavelength multiplexing/demultiplexing device 1A according to the present embodiment, since first wavelength selective filters 40 (1) to 40 (M) are optically coupled through space, each of optical signals Sλ_{M} (m=1, . . . , M) passes through only first collimator 10 and a corresponding second collimator 20 (m). That is, in all of optical signals Sλ₁ to Sλ_{M}, the number of times each of optical signals passes through the collimators is only two. Therefore, according to wavelength multiplexing/demultiplexing device 1A of the present embodiment, it is possible to suppress the loss in all of optical signals Sλ₁ to Sλ_{M}.

However, when first wavelength selective filters 40 (1) to 40 (M) are coupled through space as in the present embodiment, in order to utilize band characteristics of the thin film filter, it is necessary to reduce an incident angle of an optical signal on multilayer film 42, and it is also necessary to secure an interval between first wavelength selective filters adjacent to each other in the same row. Accordingly, interval L1 between first wavelength selective filters 40 (1), 40 (3), 40 (5), . . . , 40 (M−1) arranged in the first row and first wavelength selective filters 40 (2), 40 (4), 40 (6), . . . , 40 (M) arranged in the second row tends to be large. Therefore, a propagation length of at least one of optical signals becomes extremely long.

In general, an increase in the propagation length of an optical signal leads to an increase in a beam diameter of the optical signal. In the optical device described in Patent Document 1, in order to improve a coupling efficiency of a beam having a large diameter, a focal distance of the collimator lens is increased as a stage in which the collimator lens is disposed becomes rear. However, in this case, since it is necessary to prepare a plurality of types of collimator lenses having focal distances differing from each other, it is difficult to reduce a cost by reducing the number of components. This issue becomes more significant as the number M of optical signals Sλ₁ to Sλ_{M} increases.

In response to this issue, in wavelength multiplexing/demultiplexing device 1A of the present embodiment, first wavelength selective filter 40 (1) is optically coupled on second surface 412 of substrate 41 to first collimator lens 12. Further, first wavelength selective filter 40 (m+1) (m=1, . . . , M−1) is optically coupled on second surface 412 of substrate 41 to first wavelength selective filter 40 (m). As described above, when each of first wavelength selective filters 40 (1) to 40 (M) is fabricated, due to a difference in thermal expansion coefficient between multilayer film 42 and substrate 41, a warp is generated such that first surface 411 of substrate 41 and a surface of multilayer film 42 are convexly curved. Due to this warp, first wavelength selective filters 40 (1) to 40 (M) act as reflective concave lenses for light incident from the side of second surface 412 of substrate 41. By effectively using the concave lenses, it is possible to suppress a spread of the beam diameters of optical signals propagating between first wavelength selective filters 40 (1) to 40 (M). Therefore, according to wavelength multiplexing/demultiplexing device 1A of the present embodiment, it is possible to further increase the number M of optical signals Sλ₁ to Sλ_{M} to be demultiplexed or multiplexed. In such a configuration, it is desirable that beam waist BW is formed at the midpoint of an optical path that connects first wavelength selective filter 40 (m) and first wavelength selective filter 40 (m+1) to each other.

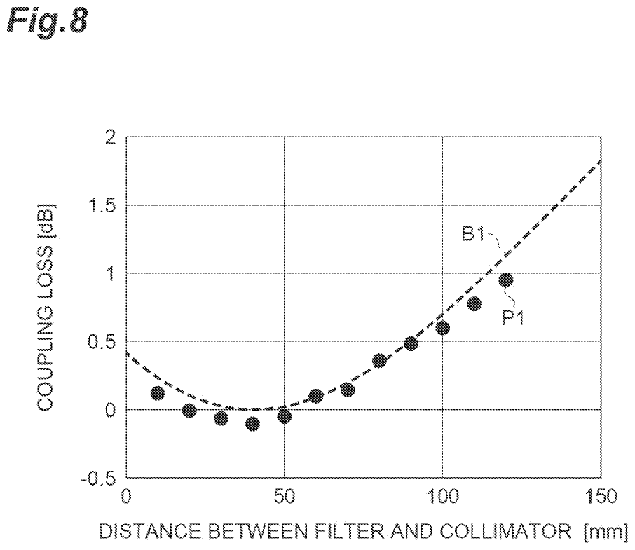

Here, lens effect of first wavelength selective filters 40 (1) to 40 (M) will be described in detail. FIG. 8 is a graph illustrating a relationship between a coupling loss and a distance between a wavelength selective filter and a collimator when light reflected from the wavelength selective filter having a transmission wavelength bandwidth suitable for DWDM at a 100 GHz interval is incident on the collimator. In FIG. 8, a horizontal axis represents a distance (unit: mm) between the wavelength selective filter and the collimator, and a vertical axis represents a coupling loss (unit: dB). In the figure, plots P1 are actual measurement values, and a broken line B1 is a theoretical curve. In the actual measurement, light having a wavelength of 1550 nm that was largely deviated from a transmission wavelength band was incident on a back surface (corresponding to second surface 412 of substrate 41) of the wavelength selective filter from the collimator, and the reflected light was received by the same collimator. A working distance of the collimator was 23 mm, and a beam diameter at a beam waist was 502 μm. In an actual measurement, since a reflectivity of a metallic mirror was used as a reference instead of a wavelength selective filter, the coupling loss was negative in some plots P1. The theoretical curve illustrates a calculation result when a surface of a multilayer film of the wavelength selective filter is assumed to be a curved surface having a radius of curvature of 1400 mm and the wavelength selective filter is regarded as a concave mirror having a focal distance of 467 mm. In the theoretical curve, an internal loss of the wavelength selective filter was defined as 0 dB. Referring to FIG. 8, it can be seen that plots P1 are in good agreement with the theoretical curve.

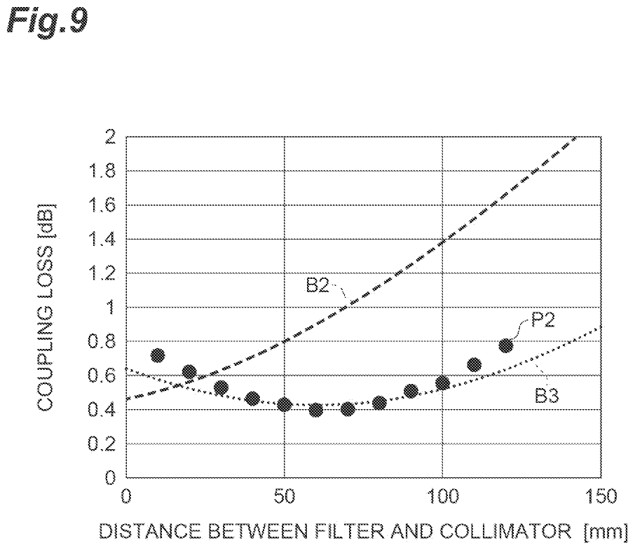

FIG. 9 illustrates a relationship between a coupling loss and a distance between the wavelength selective filter and the collimator when transmitted light from the same wavelength selective filter as that used in the actual measurement illustrated in FIG. 8 is incident on the collimator. In FIG. 9, a horizontal axis represents a distance (unit: mm) between the wavelength selective filter and the collimator, and a vertical axis represents a coupling loss (unit: dB). In the figure, plots P2 are actual measurement values, and a broken line B2 is a theoretical curve. In the actual measurement, light having a wavelength of 1539.6 nm included in the transmission wavelength band was incident on the back surface of the wavelength selective filter (corresponding to second surface 412 of substrate 41) from the first collimator, and the transmitted light was received by a second collimator. A working distance of the first collimator was 23 mm, and a beam diameter at a beam waist was 502 sm. A working distance of the second collimator was 23 mm, and the beam diameter at the beam waist was 494 μm. While a distance between the first collimator and the wavelength selective filter was fixed to 80 mm, a distance between the second collimator and the wavelength selective filter was changed. The theoretical curve illustrates a calculation result when a surface of a multilayer film of the wavelength selective filter is assumed to be a curved surface having a radius of curvature of 1400 mm, and the wavelength selective filter is regarded as a lens having a focal distance of 2800 mm. In the theoretical curve, an internal loss of the wavelength selective filter is 0.4 dB.

According to the theoretical curve, the coupling loss should monotonically increase as the distance between the second collimator and the wavelength selective filter increases. However, according to the actual measurement values, the coupling loss was minimum when the distance between the second collimator and the wavelength selective filter was approximately 60 mm to 70 mm, and a tendency significantly different from the theoretical curve was obtained. A dotted line B3 in FIG. 9 illustrates a theoretical curve when the wavelength selective filter is regarded as a lens having a focal distance of 220 mm. It can be seen that plots P2 are in good agreement with this theoretical curve. These results indicate that a lens power of the wavelength selective filter for transmitted light is about one order of magnitude larger than the theoretical value calculated from the radius of curvature of the multilayer film surface.

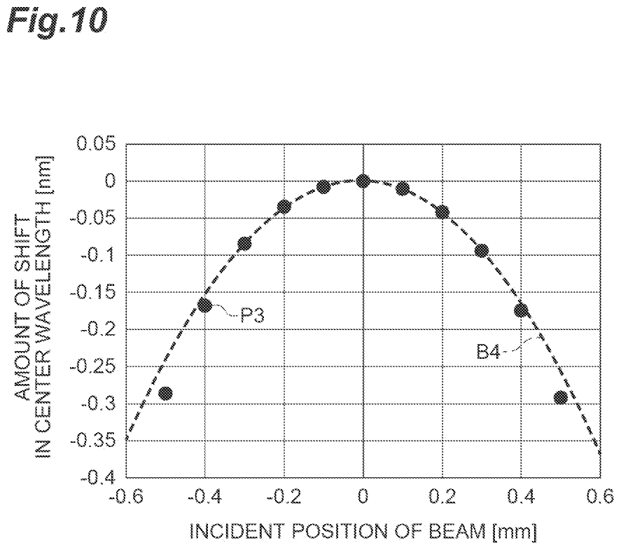

The reason why the lens effect of the wavelength selective filter on the transmitted light is more significant than the theoretical effect will be discussed below. As described above, in a wavelength selective filter, a multilayer film surface and a substrate surface are convexly curved due to a difference in thermal expansion coefficient between the multilayer film and the substrate. However, it is considered that there is also a distribution in a film thickness of the multilayer film due to a distribution of stress during thermal expansion. FIG. 10 is a graph illustrating a result of an examination of shift in a center wavelength of transmitted light as an incident position of a beam on a wavelength selective filter having a transmission wavelength bandwidth suitable for DWDM at a 100 GHz interval is moved in one direction along a surface of a substrate. In FIG. 10, a horizontal axis represents an incident position of a beam (unit: mm), and a vertical axis represents an amount of shift in the center wavelength (unit: nm). Plots P3 illustrates actual measurement values, and a curve B4 illustrates an approximate curve of plots P3. Referring to FIG. 10, it can be seen that the center wavelength of the transmitted light is shifted to a short-wavelength side as the incident position of the beam moves away from the center (0 mm) of the wavelength selective filter. This suggests that the film thickness of the multilayer film becomes gradually thinner as it moves away from the center of the wavelength selective filter.

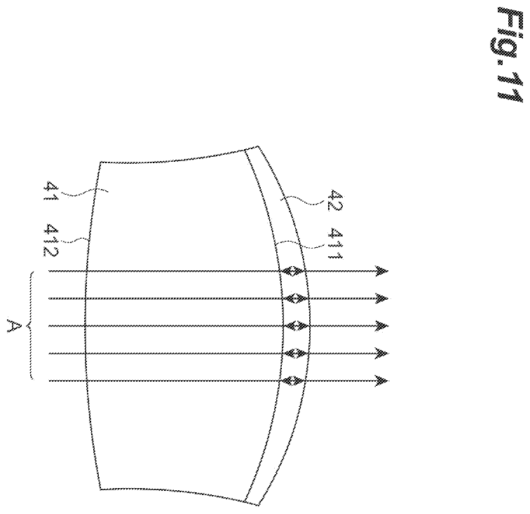

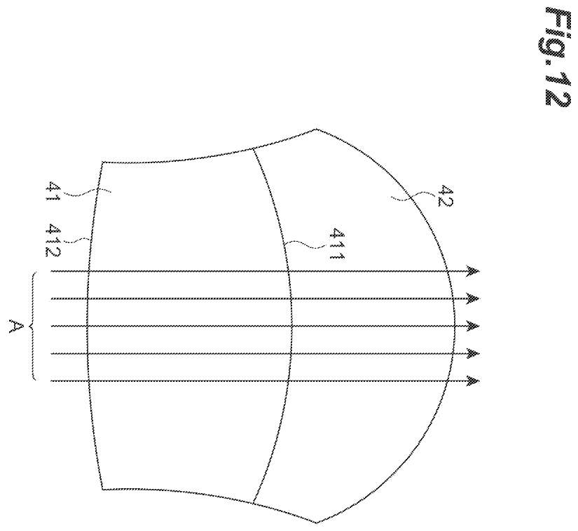

FIG. 11 is a schematic diagram illustrating a state in which a beam A is transmitted through a wavelength selective filter. As illustrated in FIG. 11, a surface of multilayer film 42 and first surface 411 of substrate 41 are convexly curved due to a difference in thermal expansion coefficient between multilayer film 42 and substrate 41. Furthermore, a film thickness of multilayer film 42 gradually decreases as it moves away from the center of first surface 411. Beam A having a wavelength included in a transmission wavelength band is transmitted through multilayer film 42 while repeating multiple reflections by a plurality of mirror layers in multilayer film 42. A propagation length of beam A increases as the film thickness increases. Therefore, when the propagation length of beam A is replaced with the film thickness, a film thickness distribution of multilayer film 42 becomes more pronounced as illustrated in FIG. 12. A curvature of the surface of multilayer film 42 viewed from beam A is equivalent to a curvature of the surface of multilayer film 42 having such a film thickness distribution, and is significantly larger than that in the case where light is transmitted through multilayer film 42 without internal reflections. Since a degree of the lens effect of the wavelength selective filter on the transmitted light is determined by the curvature of the surface of multilayer film 42, the lens effect of the wavelength selective filter is significantly larger than a lens effect calculated only from the curvature of the actual surface of multilayer film 42.

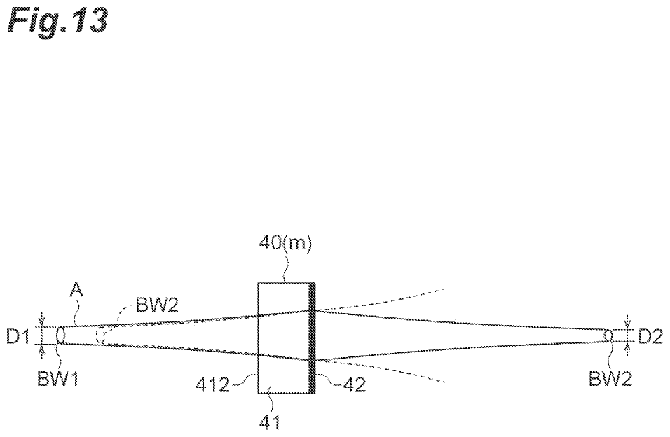

Here, FIG. 13 schematically illustrates a state in which a certain beam A is incident on second surface 412 of first wavelength selective filter 40 (m) and is transmitted through multilayer film 42 in a spatially configured MUX/DEMUX module such as wavelength multiplexing/demultiplexing device 1A of the present embodiment. A broken line indicates a contour of beam A on an emission side obtained from the lens effect calculated only from the curvature of the surface of multilayer film 42. Table illustrates interval L1 between the first row and the second row of the wavelength selective filter, a beam diameter D1 (incident beam diameter) at a beam waist BW1 on an incident side, a position (emission beam waist position) of a beam waist BW2 on the emission side, and a beam diameter D2 (emission beam diameter) at a beam waist BW2 on the emission side. The emission beam waist position represents a position when the surface of multilayer film 42 is at 0 mm and a propagation direction of beam A is in a positive direction. Table illustrates an emission beam waist position and an emission beam diameter obtained from a lens effect calculated only from the curvature of the surface of multilayer film 42, and an emission beam waist position and an emission beam diameter obtained from the actual lens effect of multilayer film 42.

TABLE

| Interval L1 [mm] | | 16 | 24 | 32 |
|---|---|---|---|---|
| Incident Beam Diameter [μm] | | 420 | 462 | 494 |
| Emission | Value calculated only from the | −6 | −9 | −11 |
| Beam Waist | curvature of the surface | | | |
| Position [mm] | | | | |
| | Actual value | 26 | 36 | 46 |
| Emission | Value calculated only from the | 421 | 463 | 496 |
| Beam | curvature of the surface | | | |
| Diameter [μm] | | | | |
| | Actual value | 403 | 434 | 457 |

As illustrated in Table, when only the curvature of the surface of multilayer film 42 is considered, the position of the emission beam waist becomes negative. That is, the position of beam waist BW2 of beam A is expected to be located on the incident side with respect to the surface of multilayer film 42 (see the broken line in FIG. 13). However, in practice, the emission beam waist position is positive and the distance from the surface of multilayer film 42 to beam waist BW2 is greater than interval L 1. Emission beam diameter D2 is substantially equal to incident beam diameter D1 when only the curvature of the surface of multilayer film 42 is considered, but is practically smaller than incident beam diameter D1. Therefore, when second collimators 20 (1) to 20 (M) are designed and arranged in consideration of only the curvature of the surface of multilayer film 42, mismatching of beam characteristics occurs between first wavelength selective filter 40 (m) (m=1, . . . , M) and a corresponding second collimators 20 (m) (m=1, . . . , M), and thus a large coupling loss is generated.

In wavelength multiplexing/demultiplexing device 1A of the present embodiment, each of first wavelength selective filters 40 (m) is optically coupled on first surface 411 of substrate 41 to second collimator lens 22 of a corresponding second collimators 20 (m). As described above, the actual lens power of the lens effect on transmitted light of multilayer film 42 due to a difference in a thermal expansion coefficient between substrate 41 and multilayer film 42 is greater than the lens power derived only from the curvature of the surface of multilayer film 42. Therefore, the distance between first wavelength selective filter 40 (m) and second collimator 20 (m) may be set such that beam waist BW2 is formed between first wavelength selective filter 40 (m) and second collimator lens 22 of second collimator 20 (m). However, in such a distance setting, the optical path between first wavelength selective filter 40 (m) and second collimator 20 (m) becomes longer, and this hinders miniaturization of wavelength multiplexing/demultiplexing device 1A.

In wavelength multiplexing/demultiplexing device 1A of the present embodiment, in each of second collimators 20 (m), a focal distance of second collimator lens 22 and a distance between second collimator lens 22 and one end of optical fiber 21 are set such that a working distance of second collimator 20 is negative. In other words, effective beam waist BW2 of optical signal Sλₘ propagating between second collimator 20 (m) and first wavelength selective filter 40 (m) is on a side opposite to first wavelength selective filter 40 (m) when viewed from an emission end of second collimator lens 22, and the emission end of second collimator lens 22 is located between the beam waist and first wavelength selective filter 40 (m). Each of second collimators 20 (m) has a configuration to efficiently couple second collimator lens 22 and optical fiber 21 while emitting diffused light from second collimator lens 22 (or receiving converging light to second collimator lens 22). Accordingly, since it is possible to suppress a mismatching of beam characteristics without forming beam waist BW2 between first wavelength selective filter 40 (m) and second collimator 20 (m), the optical path between first wavelength selective filter 40 (m) and second collimator 20 (m) can be shortened. Therefore, wavelength multiplexing/demultiplexing device 1A can be miniaturized.

In the spatially configured MUX/DEMUX module such as wavelength multiplexing/demultiplexing device 1A of the present embodiment, a propagation length of a beam constituting optical signal Sλₘ is longer than that of wavelength multiplexing/demultiplexing device 100 illustrated in FIG. 28, for example. Therefore, when a relative position and direction of each component slightly change due to expansion or contraction of constituent materials caused by a temperature change, the position and direction of the beam propagating through space greatly change. In this case, there is a possibility that coupling loss in each of collimators becomes larger. According to the present embodiment, since the optical path between first wavelength selective filter 40 (m) and second collimator 20 (m) can be shortened by making the working distances of second collimators 20 (1) to 20 (M) negative, a degree of increase in coupling loss can be reduced in response to changes in the relative position and direction of each component due to a temperature change.

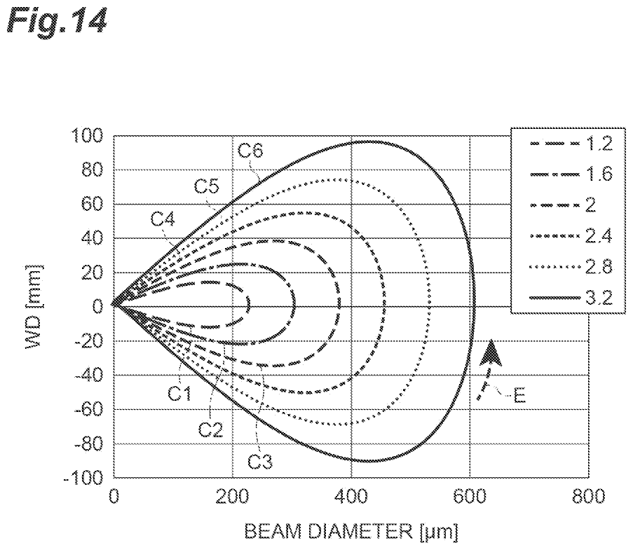

The reason why such a collimator having a negative working distance can be realized will be described. In general, a length of a collimator lens constituting the collimator in optical axis direction is shorter than a value obtained by multiplying a focal distance of the collimator lens by a refractive index of the collimator lens. In such a collimator, the working distance of the collimator and the beam diameter at a beam waist can be arbitrarily set by adjusting a distance G between an end surface of the collimator lens (corresponding to second end surface 222 illustrated in FIG. 3) and an end face of an optical fiber. FIG. 14 is a graph illustrating a relationship among a working distance (WD) of the collimator, a beam diameter at the beam waist, and a focal distance inherent to the collimator lens when distance G is changed. In FIG. 14, a horizontal axis represents a beam diameter (unit: μm) and a vertical axis represents a working distance (unit: mm). In addition, curves C1 to C6 indicate cases where the focal distances of the collimator lens are 1.2 mm, 1.6 mm, 2.0 mm, 2.4 mm, 2.8 mm, and 3.2 mm, respectively. As distance G increases, the working distance of the collimator and the beam diameter at the beam waist move in a direction indicated by an arrow E.

Referring to FIG. 14, it can be seen that the working distance of the collimator and the beam diameter at the beam waist can be adjusted even in a region where the working distance of the collimator is negative. That is, a collimator lens having a focal distance that enable a desired working distance and a desired beam diameter to be obtained is first selected, and then distance G is adjusted while measuring the working distance and the beam diameter, thereby realizing the collimator having a negative working distance of a desired magnitude. For example, in wavelength multiplexing/demultiplexing device 1A with interval L1 of 32 mm illustrated in FIG. 1, when a distance between first wavelength selective filter 40 (m) and second collimator 20 (m) is 10 mm, second collimator 20 (m) having a working distance of 10−46=−36 mm and a beam diameter of 457 mm is suitable. Such second collimator 20 (m) can be realized by appropriately adjusting distance G using second collimator lens 22 having a focal distance of, for example, 2.56 mm.

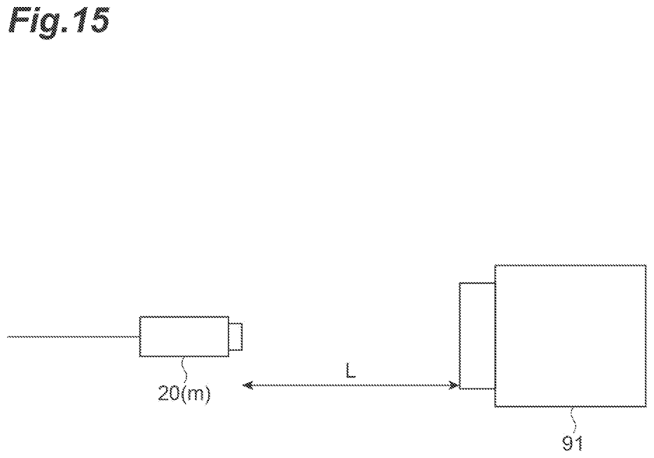

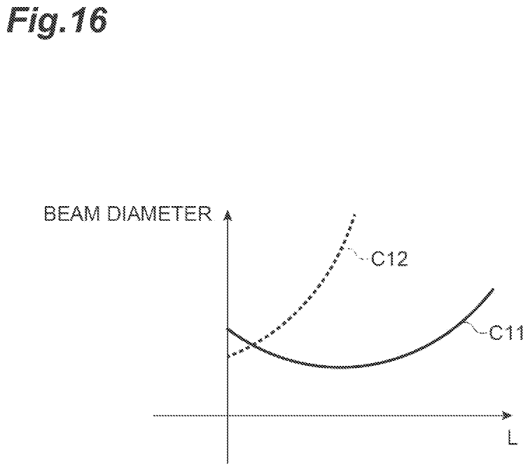

Several methods of measuring a working distance and a beam diameter of second collimator 20 (m) will now be described. In one method, as illustrated in FIG. 15, an area sensor 91 is disposed to face second collimator 20 (m), and test light is emitted from second collimator 20 (m) toward area sensor 91. In this state, the beam diameter is measured by area sensor 91 while changing a distance L from second collimator 20 (m) to area sensor 91. Then, the measurement result is fitted to a theoretical curve C11 or C12 of beam diameter versus distance L in a Gaussian beam illustrated in FIG. 16. Theoretical curve C11 indicates a case where a working distance is positive, and theoretical curve C12 indicates a case where a working distance is negative. Accordingly, the working distance and the beam diameter of second collimator 20 (m) can be measured. When the working distance is negative, a fitting error may be large, and in this case, the measurement may be performed using the following method.

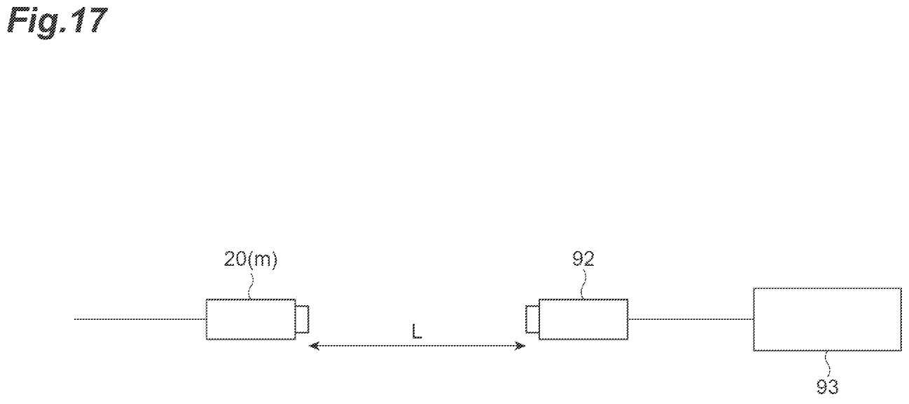

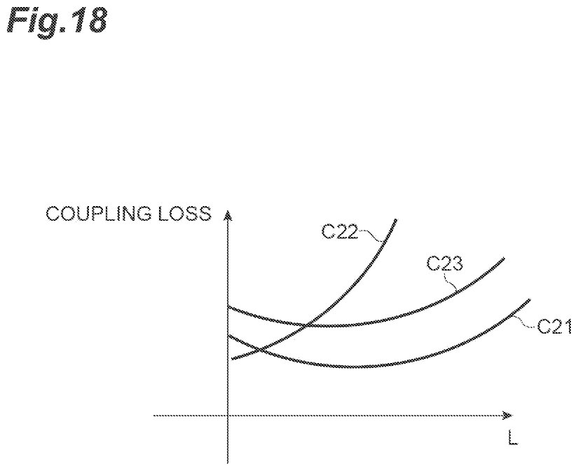

In another method, as illustrated in FIG. 17, another collimator 92 is disposed to face second collimator 20 (m), and a power sensor 93 is connected to collimator 92. Then, test light is emitted from second collimator 20 (m) toward collimator 92, and a light intensity is measured by power sensor 93 while changing distance L from second collimator 20 (m) to the collimator 92. Then, a value of coupling loss calculated from the measurement result is fitted to a theoretical curve C21, C22, or C23 of coupling loss versus distance L illustrated in FIG. 18. Theoretical curve C21 indicates a case where a working distance of second collimator 20 (m) and a working distance of collimator 92 are both positive, and theoretical curve C22 indicates a case where a working distance of second collimator 20 (m) and a working distance of collimator 92 are both negative. Theoretical curve C23 indicates a case where a working distance of second collimator 20 (m) is negative, a working distance of collimator 92 is positive, and an absolute value of the working distance of collimator 92 is greater than an absolute value of the working distance of second collimator 20 (m).

When the working distances of second collimator 20 (m) and collimator 92 are both negative, as indicated by theoretical curve C22, since a value of distance L at a minimum coupling loss is outside a measurement range, the fitting error may become large. In such a case, the working distance of collimator 92 may be made positive, and the absolute value of the working distance of collimator 92 may be made larger than the absolute value of the working distance of second collimator 20 (m). As a result, as illustrated by theoretical curve C23, the value of distance L at a minimum coupling loss can be made within the measurement range. Therefore, the working distance and the beam diameter of second collimator 20 (m) can be measured with a smaller fitting error.

In the present embodiment, the focal distance of second collimator lens 22 of each of second collimators 20 (1) to 20 (M) may be shorter than the focal distance of first collimator lens 12 of first collimator 10. In this case, as the focal distance is shorter, the amounts of changes in the beam diameter and the working distance with respect to the change in distance G is smaller, and thus a variation in beam performance of the collimators can be reduced.

In the present embodiment, the focal distance of each of second collimator lens 22 of second collimators 20 (1) to 20 (M) may be included in a range of ±5%, more preferably in a range of ±1% from a predetermined focal distance. According to wavelength multiplexing/demultiplexing device 1A of the present embodiment, since a spread of beam diameters of optical signals propagating between first wavelength selective filters 40 (1) to 40 (M) can be suppressed, the focal distance of second collimator lens 22 can be made substantially equal to each other in each of second collimators 20 (1) to 20 (M) in this manner. Therefore, the same collimator lenses can be used as an M number of second collimator lenses 22, and the number of components of wavelength multiplexing/demultiplexing device 1A can be reduced.

In the present embodiment, an interval of center wavelengths of the transmission wavelength bands between first wavelength selective filters 40 (1) to 40 (M) may be 50 GHz or more, or 100 GHz or more in terms of frequency. As the interval of center wavelengths of the transmission wavelength bands is narrower, a steeper wavelength transmission characteristic is required, and the number of laminated layers of multilayer film 42 increases. Therefore, multilayer film 42 becomes thicker, and warp of the surface of multilayer film 42 due to a difference in thermal expansion coefficient between multilayer film 42 and substrate 41 becomes significant. According to wavelength multiplexing/demultiplexing device 1A of the present embodiment, it is possible to provide a wavelength multiplexing/demultiplexing device suitable for multiplexing or demultiplexing of a wavelength multiplexed optical signal having such a narrow wavelength interval.

As illustrated in FIG. 14, the widths of the transmission wavelength bands F (1) to F (M) of first wavelength selective filters 40 (1) to 40 (M) may be equal to each other. According to wavelength multiplexing/demultiplexing device 1A of the present embodiment, it is possible to miniaturize wavelength multiplexing/demultiplexing device 1A having such a configuration.

As in this embodiment, second collimator lens 22 may be a C lens. In this case, second collimators 20 (1) to 20 (M) having negative working distances can be realized at low cost using general-purpose collimators.

As in the present embodiment, second end surface 222 of second collimator lens 22 may be inclined with respect to imaginary plane H perpendicular to optical axis AX of optical fiber 21. In this case, reflection return light inside second collimators 20 (1) to 20 (M) can be reduced.

### (First Modification)

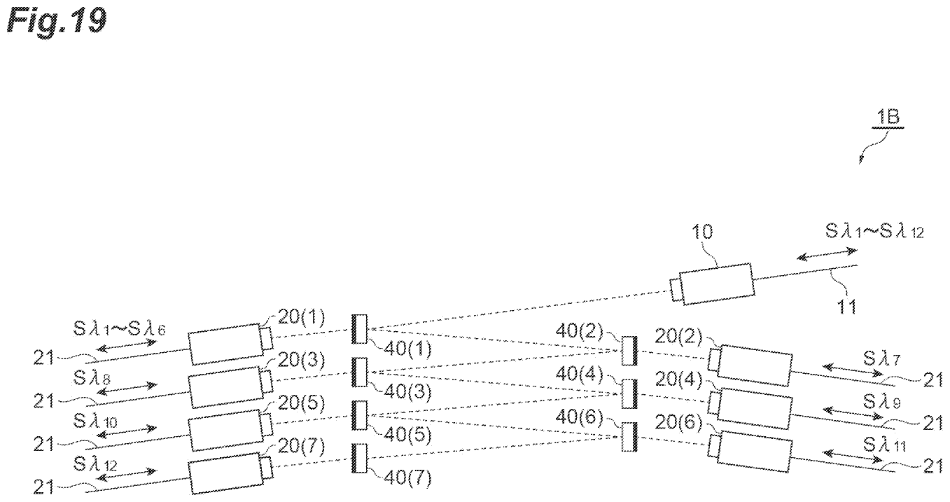

FIG. 19 is a diagram illustrating a configuration of a wavelength multiplexing/demultiplexing device 1B according to a first modification. This wavelength multiplexing/demultiplexing device 1B differs from wavelength multiplexing/demultiplexing device 1A of the above-described embodiment in transmission wavelength bands of first wavelength selective filters 40 (1) to 40 (M), and coincides with wavelength multiplexing/demultiplexing device 1A of the above-described embodiment in other respects. FIG. 19 illustrates an example in which M=7.

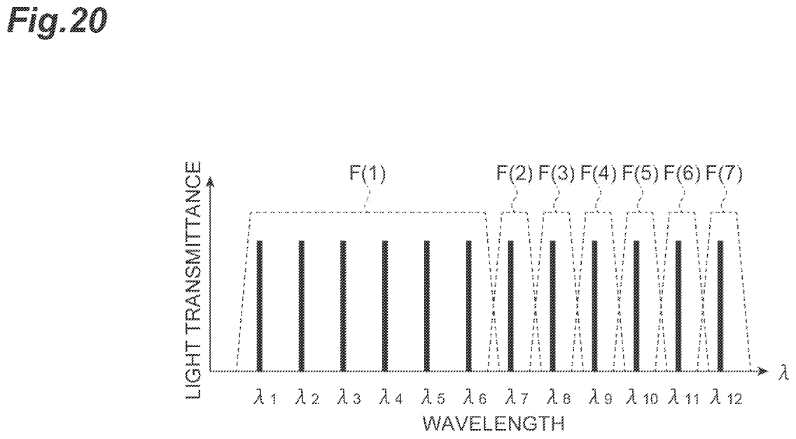

FIG. 20 is a graph illustrating a transmission wavelength band of each of first wavelength selective filters 40 (1) to 40 (M) of the present modification. In FIG. 20, a horizontal axis represents a wavelength, and a vertical axis represents a light transmittance. Broken lines in the figure indicate transmission wavelength bands F (1) to F (M) of respective first wavelength selective filters 40 (1) to 40 (M). FIG. 20 also illustrates signal wavelengths λ₁ to λ_{MA+M} of respective optical signals Sλ₁ to Sλ_{MA+M}. MA is an integer of 1 or more. FIG. 20 illustrates a case where MA=5.

As illustrated in FIG. 20, first wavelength selective filters 40 (1) to 40 (M) have transmission wavelength bands F (1) to F (M) differing from each other. In the present modification, widths of transmission wavelength bands F (2) to F (M) are equal to each other, but a width of transmission wavelength band F (1) is wider than the widths of transmission wavelength bands F (2) to F (M). Transmission wavelength band F (1) includes signal wavelengths λ₁ to λ_{MA+1}. Transmission wavelength bands F (2) to F (M) include signal wavelengths λ_{MA+2} to λ_{MA+M}, respectively. In one example, a center wavelength of transmission wavelength band F (1) is an intermediate wavelength between signal wavelength λ₁ and signal wavelength λ_{MA+1}, and center wavelengths of transmission wavelength bands F (2) to F (M) are signal wavelengths λ_{MA+2} to λ_{MA+M}, respectively.

Referring to FIG. 19, when optical signals Sλ₁ to Sλ_{MA+M} are demultiplexed, first, a wavelength multiplexed optical signal including optical signals Sλ₁ to Sλ_{MA+M} reaches first wavelength selective filter 40 (1) from optical fiber 11 of first collimator 10 through first collimator lens 12. Optical signals Sλ₁ to Sλ_{MA+1} are transmitted through first wavelength selective filter 40 (1) and are output to the outside of wavelength multiplexing/demultiplexing device 1B through second collimator lens 22 and optical fiber 21 of second collimator 20 (1). The remaining optical signals Sλ_{MA+2} to Sλ_{MA+M} are reflected by first wavelength selective filter 40 (1) and reach first wavelength selective filter 40 (2). Thereafter, in the same manner as in the above-described embodiment, each of optical signals Sλ_{MA+2} to Sλ_{MA+M} is sequentially demultiplexed for each wavelength and output to the outside of wavelength multiplexing/demultiplexing device 1B.

In addition, when optical signals Sλ₁ to Sλ_{M+MA} are multiplexed, first, each of optical signals Sλ_{MA+2} to Sλ_{MA+M} is sequentially multiplexed for each wavelength in the same manner as in the above-described embodiment. The multiplexed optical signal including optical signals Sλ_{MA+2} to Sλ_{MA+M} reaches first wavelength selective filter 40 (1). At the same time, optical signals Sλ₁ to Sλ_{MA+1} reach first wavelength selective filter 40 (1) from optical fiber 21 of second collimator 20 (1) through second collimator lens 22. Optical signals Sλ₁ to Sλ_{MA+1} are transmitted through first wavelength selective filter 40 (1) and multiplexed with optical signals Sλ_{MA+2} to Sλ_{MA+M} to generate a wavelength multiplexed optical signal. The generated wavelength multiplexed optical signal reaches first collimator 10 from first wavelength selective filter 40 (1) and is output to the outside of wavelength multiplexing/demultiplexing device 1B from optical fiber 11 of first collimator 10.

As in wavelength multiplexing/demultiplexing device 1B of the present modification, the width of the transmission wavelength band of at least one of first wavelength selective filters may differ from the width of the transmission wavelength band of each of the others of first wavelength selective filters. Even in such a case, in each of second collimators 20 (1) to 20 (M), a focal distance of second collimator lens 22 and distance G between second collimator lens 22 and one end of optical fiber 21 are set such that a working distance of second collimator 20 is negative. With this configuration, an optical path between each of first wavelength selective filters 40 (1) to 40 (M) and a corresponding second collimator of second collimators 20 (1) to 20 (M) can be shortened. Therefore, wavelength multiplexing/demultiplexing device 1B can be miniaturized.

### (Second Modification)

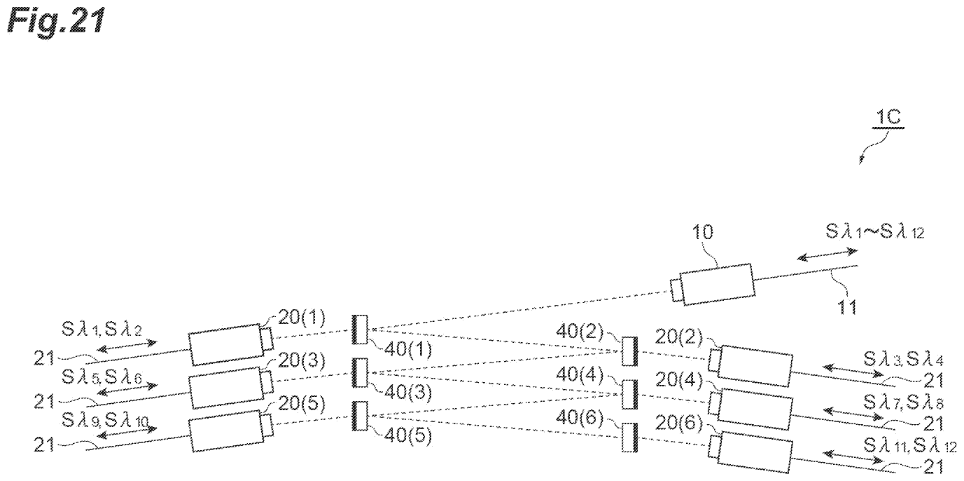

FIG. 21 is a diagram illustrating a configuration of a wavelength multiplexing/demultiplexing device 1C according to a second modification. This wavelength multiplexing/demultiplexing device 1C differs from wavelength multiplexing/demultiplexing device 1A of the above-described embodiment in transmission wavelength bands of first wavelength selective filters 40 (1) to 40 (M), and coincides with wavelength multiplexing/demultiplexing device 1A of the above-described embodiment in other respects. FIG. 21 illustrates a case where M=6.

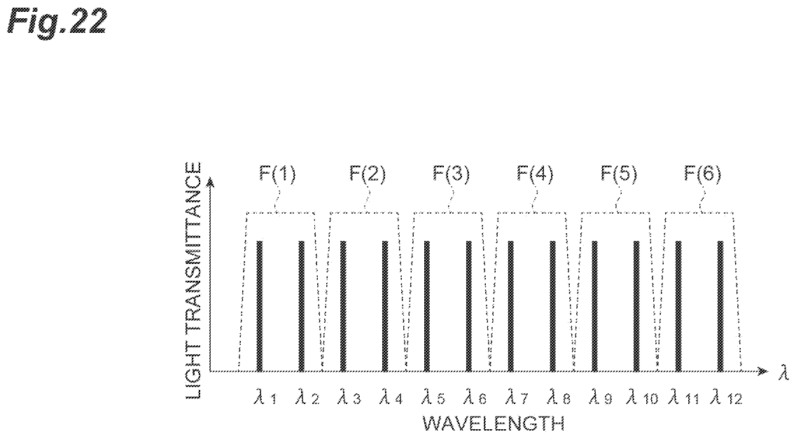

FIG. 22 is a graph illustrating a transmission wavelength band of each of first wavelength selective filters 40 (1) to 40 (M) according to the present modification. In FIG. 22, a horizontal axis represents a wavelength, and a vertical axis represents a light transmittance. Broken lines in the figure indicate transmission wavelength bands F (1) to F (M) of respective first wavelength selective filters 40 (1) to 40 (M). FIG. 22 also illustrates signal wavelengths λ₁ to λ_{2M} of respective optical signals Sλ₁ to Sλ_{2M}.

As illustrated in FIG. 22, first wavelength selective filters 40 (1) to 40 (M) have transmission wavelength bands F (1) to F (M) differing from each other. In the present modification, widths of the transmission wavelength bands F (1) to F (M) are equal to each other. Transmission wavelength band F (1) includes signal wavelengths λ₁ and λ₂. Transmission wavelength band F (2) includes signal wavelengths λ₃ and λ₄. Thereafter, in the same manner, transmission wavelength band F (m) includes signal wavelengths λ₂ₘ₋₁ and λ₂ₘ. As described above, each of transmission wavelength bands F (1) to F (M) includes two signal wavelengths. In one example, a center wavelength of transmission wavelength bands F (m) is an intermediate wavelength between signal wavelength λ₂ₘ₋₁ and signal wavelength λ₂ₘ. Each of transmission wavelength bands F (1) to F (M) may include three or more signal wavelengths.

Referring to FIG. 21, when optical signals Sλ₁ to Sλ_{2M} are demultiplexed, first, a wavelength multiplexed optical signal including optical signals Sλ₁ to Sλ_{2M} reaches first wavelength selective filter 40 (1) from optical fiber 11 of first collimator 10 through first collimator lens 12. Optical signals Sλ₁ and Sλ₂ are transmitted through first wavelength selective filter 40 (1) and are output to the outside of wavelength multiplexing/demultiplexing device 1C through second collimator lens 22 and optical fiber 21 of second collimator 20 (1). The remaining optical signals Sλ₃ to Sλ_{2M} are reflected by first wavelength selective filter 40 (1) and reach first wavelength selective filter 40 (2). Thereafter, each of optical signals Sλ₃ to Sλ_{2M} is demultiplexed for two each of wavelengths and is output to the outside of wavelength multiplexing/demultiplexing device 1C.

In addition, when optical signals Sλ₁ to Sλ_{2M} are multiplexed, first, optical signals S λ_{2M-1} and Sλ_{2M} reach first wavelength selective filter 40 (M) from optical fiber 21 of second collimator 20 (M) through second collimator lens 22. Optical signals Sλ_{2M-1} and Sλ_{2M} are transmitted through first wavelength selective filter 40 (M), reach first wavelength selective filter 40 (M−1), and are reflected by first wavelength selective filter 40 (M−1). At the same time, optical signals Sλ_{2M-3} and Sλ_{2M-2} reach first wavelength selective filter 40 (M−1) from optical fiber 21 of second collimator 20 (M−1) through second collimator lens 22. Optical signals Sλ_{2M-3} and Sλ_{2M-2} are transmitted through first wavelength selective filter 40 (M−1) and are multiplexed with optical signals Sλ_{2M-1} and Sλ_{2M}. Thereafter, optical signals from Sλ_{2M-5} and Sλ_{2M-4} down to Sλ₁ and Sλ₂ are sequentially multiplexed in the same manner to generate a wavelength multiplexed optical signal. The generated wavelength multiplexed optical signal reaches first collimator 10 from first wavelength selective filter 40 (1) and is output to the outside of wavelength multiplexing/demultiplexing device 1C from optical fiber 11 of first collimator 10.

As in wavelength multiplexing/demultiplexing device 1C of the present modification, each of transmission wavelength bands F (1) to F (M) of first wavelength selective filters 40 (1) to 40 (M) may include a plurality of signal wavelengths. Even in such a case, in second collimators 20 (1) to 20 (M), a focal distance of second collimator lens 22 and a distance between second collimator lens 22 and one end of optical fiber 21 are set such that a working distance of second collimator 20 is negative. With this configuration, an optical path between each of first wavelength selective filters 40 (1) to 40 (M) and a corresponding second collimators of second collimators 20 (1) to 20 (M) can be shortened. Therefore, wavelength multiplexing/demultiplexing device 1C can be miniaturized.

### (Third Modification)

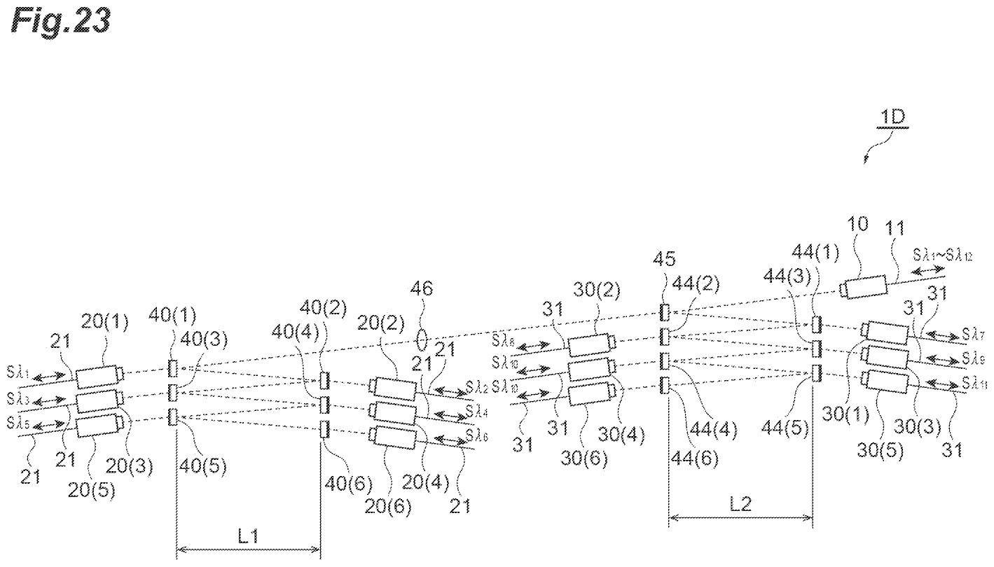

FIG. 23 is a diagram illustrating a configuration of a wavelength multiplexing/demultiplexing device 1D according to a third modification. Wavelength multiplexing/demultiplexing device 1D further includes a N number of third collimators 30 (1) to 30 (N), the N number of second wavelength selective filters 44 (1) to 44 (N), and a third wavelength selective filter 45, in addition to the configuration of wavelength multiplexing/demultiplexing device 1A of the above embodiment. N is an integer of 2 or more. N may be equal to or different from the number M of second collimators 20 (1) to 20 (M) and the number M of first wavelength selective filters 40 (1) to 40 (M). FIG. 23 illustrates a case where M=6 and N=6.

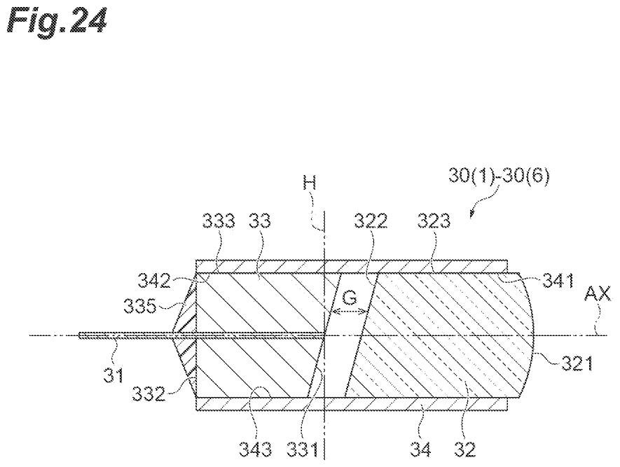

FIG. 24 is a cross-sectional view illustrating a configuration of third collimators 30 (1) to 30 (N). Each of third collimators 30 (1) to 30 (N) has the same configuration as those of first collimator 10 and second collimators 20 (1) to 20 (M) described above. Third collimators 30 (1) to 30 (N) each include an optical fiber 31 (third optical waveguide), a third collimator lens 32, a ferrule 33, and a capillary 34.

Optical fiber 31 has the same configuration as that of optical fiber 11 of first collimator 10. Ferrule 33 is a columnar member, and has a first end surface 331, a second end surface 332, and an outer peripheral surface 333. First end surface 331 and second end surface 332 are flat and intersect with a central axis of ferrule 33. Outer peripheral surface 333 connects first end surface 331 and second end surface 332 to each other. Ferrule 33 is attached to a tip of optical fiber 31. A through hole is formed in ferrule 33 along the central axis of ferrule 33. Optical fiber 31 is inserted into the through hole of ferrule 33. The central axis of ferrule 33 coincides with an optical axis AX of optical fiber 31. An end face of optical fiber 31 is exposed at first end surface 331, and is polished together with first end surface 331 to be flush with first end surface 331. The end face of optical fiber 31 and first end surface 331 are inclined with respect to an imaginary plane H perpendicular to optical axis AX of optical fiber 31. In one example, an inclination angle of first end surface 331 with respect to imaginary plane H is equal to the inclination angle of first end surface 231 of each of second collimators 20 (1) to 20 (M). Second end surface 332 is provided with a resin adhesive 335 for fixing optical fiber 31 to ferrule 33. Ferrule 33 can be made of the same material as ferrule 23 of each of second collimators 20 (1) to 20 (M).

Third collimator lens 32 is a columnar lens component. Third collimator lens 32 can be made of the same material as second collimator lens 22 of each of second collimators 20 (1) to 20 (M). Third collimator lens 32 has a first end surface 321, a second end surface 322, and an outer peripheral surface 323. First end surface 321 and second end surface 322 intersect a central axis of third collimator lens 32. Outer peripheral surface 323 connects first end surface 321 and second end surface 322 to each other. First end surface 321 is a spherical surface and functions as a convex lens. In one example, a focal distance of third collimator lens 32 is equal to the focal distance of second collimator lens 22 of each of second collimators 20 (1) to 20 (M). The focal distance of third collimator lens 32 is shorter than the focal distance of first collimator lens 12. Second end surface 322 is flat, and faces one end face of optical fiber 31 with a distance G therebetween to be optically coupled to the one end face. Third collimator lens 32 is referred to as a C lens. Second end surface 322 of third collimator lens 32 is inclined with respect to imaginary plane H. In one example, an inclination angle of second end surface 322 with respect to imaginary plane H is equal to the inclination angle of second end surface 222 of each of second collimators 20 (1) to 20 (M).

Capillary 34 is a cylindrical member that houses third collimator lens 32 and ferrule 33. Capillary 34 can be made of the same material as capillary 24 of each of second collimators 20 (1) to 20 (M). Third collimator lens 32 is inserted from a first opening 341 of capillary 34. Ferrule 33 is inserted from a second opening 342 of capillary 34. Outer peripheral surface 323 of third collimator lens 32 and outer peripheral surface 333 of ferrule 33 are in contact with inner peripheral surface 343 of capillary 34. The end face of optical fiber 31 and second end surface 322 of third collimator lens 32 face each other in an inner space of capillary 34. Capillary 34 holds third collimator lens 32 and ferrule 33 such that optical axis AX of optical fiber 31 and the central axis of third collimator lens 32 coincide with each other.

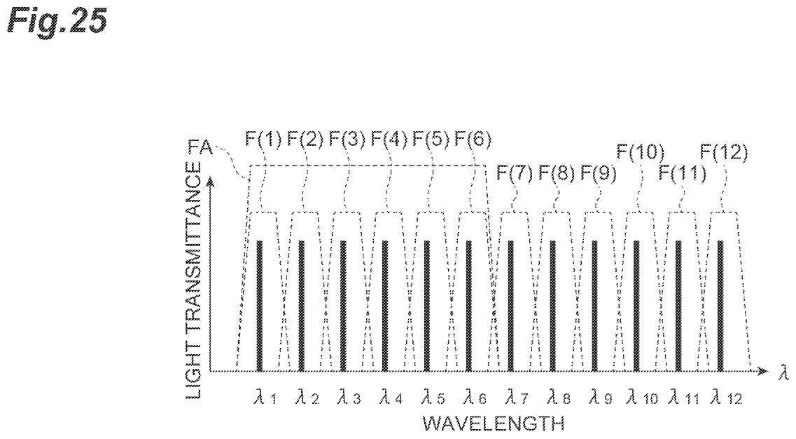

Referring to FIG. 23, second wavelength selective filters 44 (1) to 44 (N) have the same configurations as those of first wavelength selective filters 40 (1) to 40 (M). Second wavelength selective filters 44 (1) to 44 (N) each include substrate 41 and multilayer film 42 illustrated in FIG. 4. FIG. 25 is a graph illustrating a transmission wavelength band of each of first wavelength selective filters 40 (1) to 40 (M) and second wavelength selective filters 44 (1) to 44 (N). In FIG. 25, a horizontal axis represents a wavelength, and a vertical axis represents a light transmittance. Broken lines in the figure indicate transmission wavelength bands F (1) to F (M+N). In FIG. 25, signal wavelengths λ₁ to λ_{M+N} of respective optical signals Sλ₁ to Sλ_{M+N} are also illustrated.

Multilayer film 42 of each of first wavelength selective filters 40 (1) to 40 (M) has respective transmission wavelength bands F (1) to F (M). Multilayer film 42 of each of second wavelength selective filters 44 (1) to 44 (N) has respective transmission wavelength bands F (M+1) to F (M+N). Transmission wavelength bands F (1) to F (M) differ from each other. Transmission wavelength bands F (M+1) to F (M+N) differ from each other and differ from transmission wavelength bands F (1) to F (M). In one example, widths of transmission wavelength bands F (1) to F (M+N) are uniform. Each of transmission wavelength bands F (1) to F (M+N) includes a corresponding signal wavelength of signal wavelengths λ₁ to λ_{M+N}. In one example, each of signal wavelengths λ₁ to λ_{M+N} is a center wavelength of respective transmission wavelength bands F (1) to F (M+N).

As illustrated in FIG. 23, second wavelength selective filters 44 (1) to 44 (N) are arranged in two rows of a third row and a fourth row, and are arranged such that the positions of the second wavelength selective filters in an array direction are made alternate between the third row and the fourth row. Specifically, second wavelength selective filters 44 (1), 44 (3), 44 (5), . . . , 44 (N−1) in odd-numbered order are arranged in a row in this order to form the third row. Second wavelength selective filters 44 (2), 44 (4), 44 (6), . . . , 44 (N) in even-numbered order are arranged in a row in this order to form the fourth row. These rows are arranged in the same direction. In the array direction of these rows, second wavelength selective filter 44 (2) is located between second wavelength selective filter 44 (1) and second wavelength selective filter 44 (3). The same applies to the subsequent second wavelength selective filters 44 (3) to 44 (N−1). That is, in the array direction of these rows, second wavelength selective filter 44 (n) in nth (n=2, . . . , N−1) order is located between second wavelength selective filter 44 (n−1) and second wavelength selective filter 44 (n+1). Second surface 412 of substrate 41 of each of second wavelength selective filters 44 (1), 44 (3), 44 (5), . . . , 44 (N−1) in the third row is oriented toward the fourth row. Second surface 412 of substrate 41 of each of second wavelength selective filters 44 (2), 44 (4), 44 (6), . . . , 44 (N) in the fourth row is oriented toward the third row. In one example, an interval L2 between second wavelength selective filters 44 (1), 44 (3), 44 (5), . . . , 44 (N−1) in the third row and second wavelength selective filters 44 (2), 44 (4), 44 (6), . . . , 44 (N) in the fourth row is equal to interval L1.

Third wavelength selective filter 45 has the same configuration as those of first wavelength selective filters 40 (1) to 40 (M) and second wavelength selective filters 44 (1) to 44 (N). Third wavelength selective filter 45 includes substrate 41 and multilayer film 42 illustrated in FIG. 4. Multilayer film 42 of third wavelength selective filter 45 has a transmission wavelength band FA illustrated in FIG. 25. Transmission wavelength band FA includes all of transmission wavelength bands F (1) to F (M) of first wavelength selective filters 40 (1) to 40 (M), and does not include any of transmission wavelength bands F (M+1) to F (M+N) of second wavelength selective filters 44 (1) to 44 (N).

In the present modification, first collimator 10 is optically coupled linearly and spatially to second collimator 20 (1) through third wavelength selective filter 45 and first wavelength selective filter 40 (1). That is, an optical path that connects optical fiber 11 of first collimator 10 (see FIG. 2) and optical fiber 21 of second collimator 20 (1) (see FIG. 3) to each other passes through first collimator lens 12, third wavelength selective filter 45, first wavelength selective filter 40 (1), and second collimator lens 22 of second collimator 20 (1). Third wavelength selective filter 45 is optically coupled on second surface 412 of substrate 41 to first collimator lens 12 via the optical path. Third wavelength selective filter 45 is optically coupled on first surface 411 of substrate 41 to first wavelength selective filter 40 (1) via the optical path. A lens 46 for suppressing a spread of a beam may be further provided on the optical path between the third wavelength selective filter 45 and first wavelength selective filter 40 (1).

Second surface 412 of substrate 41 of third wavelength selective filter 45 is optically coupled linearly and spatially to third collimator 30 (1) in first order via second wavelength selective filter 44 (1) in first order. That is, an optical path that connects second surface 412 of substrate 41 of third wavelength selective filter 45 and optical fiber 31 of third collimator 30 (1) to each other passes through second wavelength selective filter 44 (1) and third collimator lens 32 of the third collimator 30 (1). Second wavelength selective filter 44 (1) is optically coupled on second surface 412 of substrate 41 to third wavelength selective filter 45 via the optical path. Second wavelength selective filter 44 (1) is optically coupled on first surface 411 of substrate 41 to third collimator lens 32 of third collimator 30 (1) via the optical path.

Second surface 412 of substrate 41 of second wavelength selective filter 44 (1) is optically coupled linearly and spatially to third collimator 30 (2) in second order through second wavelength selective filter 44 (2) in second order. That is, an optical path that connects second surface 412 of substrate 41 of second wavelength selective filter 44 (1) and optical fiber 31 of the third collimator 30 (2) to each other passes through second wavelength selective filter 44 (2) and third collimator lens 32 of third collimator 30 (2). Second wavelength selective filter 44 (2) is optically coupled on second surface 412 of substrate 41 to second wavelength selective filter 44 (1) via the optical path. Second wavelength selective filter 44 (2) is optically coupled on first surface 411 of substrate 41 to third collimator lens 32 of third collimator 30 (2) via the optical path. Third collimators 30 (3) to 30 (N) in third and more order and second wavelength selective filters 44 (3) to 44 (N) in third and more order are also arranged in the same manner.

In other words, the above configuration is as follows. Second surface 412 of substrate 41 of second wavelength selective filter 44 (n) in nth (n=1, . . . , N−1) order is optically coupled linearly and spatially to third collimator 30 (n+1) in (n+1)th order through second wavelength selective filter 44 (n+1) in (n+1)th order. That is, an optical path that connects 15 second surface 412 of substrate 41 of second wavelength selective filter 44 (n) and optical fiber 31 of third collimator 30 (n+1) to each other passes through second wavelength selective filter 44 (n+1) and third collimator lens 32 of third collimator 30 (n+1). Second wavelength selective filter 44 (n+1) is optically coupled on second surface 412 of substrate 41 to second wavelength selective filter 44 (n) via the optical path. Second wavelength selective filter 44 (n+1) is optically coupled on first surface 411 of substrate 41 to third collimator lens 32 of third collimator 30 (n+1) via the optical path.

A distance between second wavelength selective filter 44 (n) (n=1, . . . , N−1) and second wavelength selective filter 44 (n+1) is set such that a beam waist is formed therebetween. However, a distance between third collimator 30 (n) (n=1, . . . , N) and second wavelength selective filter 44 (n) is set such that no beam waist is formed therebetween. Therefore, in each of third collimators 30 (1) to 30 (N), a focal distance of third collimator lens 32 and distance G between third collimator lens 32 and one end of optical fiber 31 are set such that a working distance of third collimator 30 (n) is negative. In one example, the working distance of each of third collimators 30 (1) to 30 (N) is equal to the working distance of each of second collimators 20 (1) to 20 (M).

When optical signals Sλ₁ to Sλ_{M+N} are demultiplexed, first, a wavelength multiplexed optical signal including optical signals Sλ₁ to Sλ_{M+N} reaches third wavelength selective filter 45 from optical fiber 11 of first collimator 10 through first collimator lens 12. Optical signals Sλ₁ to Sλ_{M} are transmitted through third wavelength selective filter 45 and reach first wavelength selective filter 40 (1). The subsequent manner of demultiplexing optical signals Sλ₁ to Sλ_{M} is the same as that in the above-described embodiment. Optical signals Sλ_{M+1} to Sλ_{M+N} are reflected by third wavelength selective filter 45 and reach second wavelength selective filter 44 (1). Optical signal Sλ_{M+1} is transmitted through second wavelength selective filter 44 (1) and is output to the outside of wavelength multiplexing/demultiplexing device 1D through third collimator lens 32 and optical fiber 31 of third collimator 30 (1). The remaining optical signals Sλ_{M+2} to Sλ_{M+N} are reflected by second wavelength selective filter 44 (1) and reach second wavelength selective filter 44 (2). Thereafter, each of optical signals Sλ_{M+2} to Sλ_{M+N} is sequentially demultiplexed for each wavelength and is output to the outside of wavelength multiplexing/demultiplexing device 1D.

In addition, when optical signals Sλ₁ to Sλ_{M+N} are multiplexed, optical signals Sλ₁ to Sλ_{M} are multiplexed in the same manner as in the embodiment described above. The multiplexed optical signal including optical signals Sλ₁ to Sλ_{M} is transmitted through third wavelength selective filter 45. Also, optical signal Sλ_{M+N} reaches second wavelength selective filter 44 (N) from optical fiber 31 of third collimator 30 (N) through third collimator lens 32. Optical signal Sλ_{M+N} is transmitted through second wavelength selective filter 44 (N) to reach second wavelength selective filter 44 (N−1), and is reflected by second wavelength selective filter 44 (N−1). At the same time, optical signal Sλ_{M+N-1} reaches second wavelength selective filter 44 (N−1) from optical fiber 31 of third collimator 30 (N−1) through third collimator lens 32. Optical signal Sλ_{M+N-1} is transmitted through second wavelength selective filter 44 (N−1) and is multiplexed with optical signal Sλ_{M+N}. Thereafter, each of optical signals Sλ_{M+N-2} to Sλ_{M+1} is sequentially multiplexed in the same manner. The multiplexed optical signal including optical signals Sλ_{M+1} to Sλ_{M+N} is reflected by third wavelength selective filter 45 and is multiplexed with the multiplexed optical signal including optical signals Sλ₁ to Sλ_{M}. Thus, a wavelength multiplexed optical signal including optical signals Sλ₁ to Sλ_{M+N} is generated. The generated wavelength multiplexed optical signal is output from optical fiber 11 of first collimator 10 to the outside of wavelength multiplexing/demultiplexing device 1D.

Also in each of second wavelength selective filters 44 (1) to 44 (N) of the present modification, a warp is generated such that first surface 411 of substrate 41 and a surface of multilayer film 42 are convexly curved. Due to this warp, second wavelength selective filters 44 (1) to 44 (N) act as reflective concave lenses for light incident from second surface 412 of substrate 41. Therefore, similarly to first wavelength selective filter 40 (1), second wavelength selective filter 44 (1) is optically coupled on second surface 412 of substrate 41 to third wavelength selective filter 45. Further, second wavelength selective filter 44 (n+1) is optically coupled on second surface 412 of substrate 41 to second wavelength selective filter 44 (n). Therefore, even when the number of optical signals included in the wavelength multiplexed optical signal increases, it is possible to suppress a spread of beam diameters of optical signals propagating between second wavelength selective filters 44 (1) to 44 (N) by effectively using the concave lenses described above.

Furthermore, in this wavelength multiplexing/demultiplexing device 1D, as in the above embodiment, a focal distance of third collimator lens 32 of each of third collimators 30 (1) to 30 (N) and a distance G between third collimator lens 32 and one end face of optical fiber 31 are set such that a working distance of each of third collimators 30 (1) to 30 (N) is negative. Accordingly, it is not necessary to form a beam waist between each of second wavelength selective filters 44 (1) to 44 (N) and a corresponding third collimator lens 32, and an optical path between each of second wavelength selective filters 44 (1) to 44 (N) and a corresponding third collimator of third collimators 30 (1) to 30 (N) can be shortened. Therefore, wavelength multiplexing/demultiplexing device 1D can be miniaturized.

### (Fourth Modification)

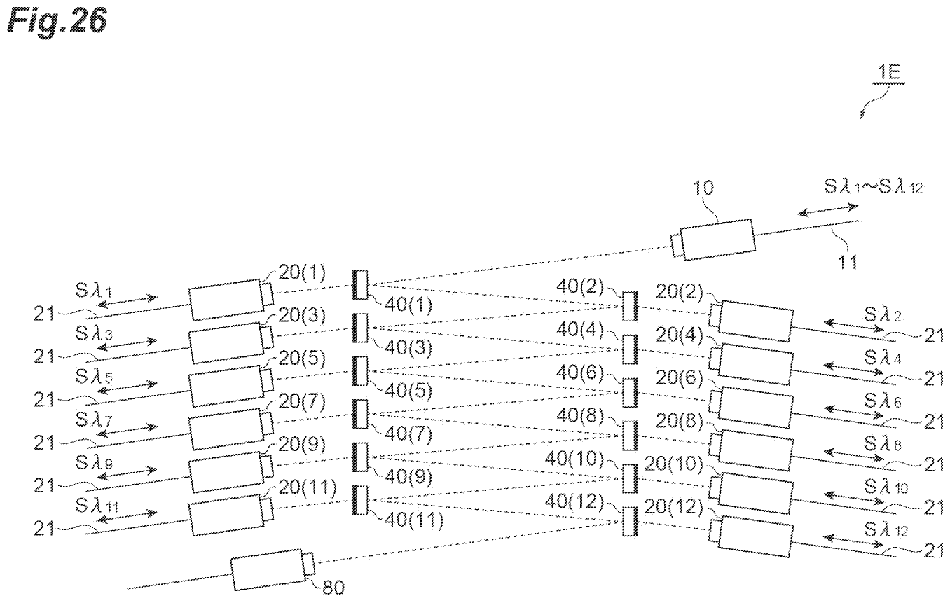

FIG. 26 is a diagram illustrating a configuration of a wavelength multiplexing/demultiplexing device 1E according to a fourth modification. This wavelength multiplexing/demultiplexing device 1E further includes a fourth collimator 80 in addition to the configuration of wavelength multiplexing/demultiplexing device 1A of the above embodiment. Fourth collimator 80 can be used as a port for upgrading. A configuration of fourth collimator 80 is the same as that of first collimator 10. Fourth collimator 80 is disposed to face second surface 412 of substrate 41 of first wavelength selective filter 40 (M) and is optically coupled to second surface 412 of substrate 41 of first wavelength selective filter 40 (M) through space. According to this modification, wavelength multiplexing/demultiplexing device 1E having a port for upgrading can be miniaturized.

### (Fifth Modification)

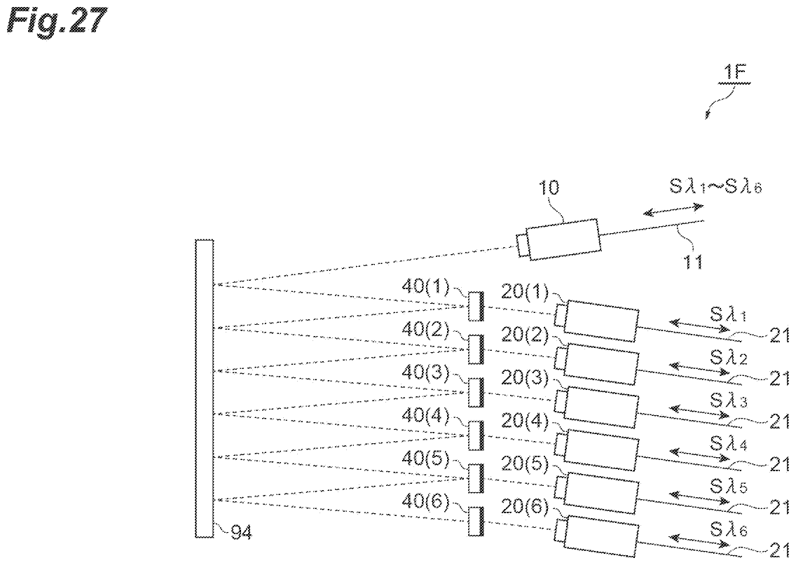

FIG. 27 is a diagram illustrating a configuration of a wavelength multiplexing/demultiplexing device 1F according to a fifth modification. In wavelength multiplexing/demultiplexing device 1F, an M number of second collimators 20 (1) to 20 (M) (for example, M=6 in the figure) are arranged in one row, and first wavelength selective filters 40 (1) to 40 (M) corresponding to respective second collimators 20 (1) to 20 (M) are also arranged in one row. Wavelength multiplexing/demultiplexing device 1F further includes a flat mirror 94. Mirror 94 faces second collimators 20 (1) to 20 (M) with first wavelength selective filters 40 (1) to 40 (M) interposed therebetween. Mirror 94 faces first collimator 10.

When optical signals Sλ₁ to Sλ_{M} are demultiplexed, first, a wavelength multiplexed optical signal including optical signals Sλ₁ to Sλ_{M} reaches mirror 94 from optical fiber 11 of first collimator 10 through first collimator lens 12. The wavelength multiplexed optical signal is reflected by mirror 94 and reaches first wavelength selective filter 40 (1). Optical signal Sλ₁ is transmitted through first wavelength selective filter 40 (1) and is output to the outside of wavelength multiplexing/demultiplexing device 1F through second collimator lens 22 and optical fiber 21 of second collimator 20 (1). The remaining optical signals Sλ₂ to Sλ_{M} are reflected by first wavelength selective filter 40 (1) and are reflected again by mirror 94 to reach first wavelength selective filter 40 (2). Thereafter, each of optical signals Sλ₂ to Sλ_{M} is sequentially demultiplexed for each wavelength in the same manner and is output to the outside of wavelength multiplexing/demultiplexing device 1F.

When optical signals Sλ₁ to Sλ_{M} are multiplexed, first, optical signal Sλ_{M} reaches first wavelength selective filter 40 (M) from optical fiber 21 of second collimator 20 (M) through second collimator lens 22. Optical signal Sλ_{M} is transmitted through first wavelength selective filter 40 (M) and reaches mirror 94. Optical signal SAM is reflected by mirror 94 to reach first wavelength selective filter 40 (M−1), and is reflected again by first wavelength selective filter 40 (M−1). At the same time, optical signal Sλ_{M-1} reaches first wavelength selective filter 40 (M−1) from optical fiber 21 of second collimator 20 (M−1) through second collimator lens 22. Optical signal Sλ_{M-1} is transmitted through first wavelength selective filter 40 (M−1) and is multiplexed with optical signal Sλ_{M}. Thereafter, optical signals Sλ_{M-2} to Sλ₁ is sequentially multiplexed in the same manner to generate a wavelength multiplexed optical signal. The generated wavelength multiplexed optical signal reaches mirror 94 from first wavelength selective filter 40 (1), and reaches first collimator 10 after being reflected by mirror 94. The wavelength multiplexed optical signal is output from optical fiber 11 of first collimator 10 to the outside of wavelength multiplexing/demultiplexing device 1F.

The wavelength multiplexing/demultiplexing device according to the present disclosure is not limited to the above-described embodiments, and various other modifications are possible. For example, the above-described embodiments illustrate a case where the wavelength selective filter is a DWDM filter, but the wavelength selective filter may be any filter having any wavelength interval, such as a coarse wavelength division multiplexing (CWDM) filter.

What is claimed is:

1. A wavelength multiplexing/demultiplexing device comprising:
a first collimator including a first optical waveguide and a first collimator lens optically coupled to one end of the first optical waveguide;
an M number (M is an integer of 2 or more) of second collimators each including a second optical waveguide and a second collimator lens optically coupled to one end of the second optical waveguide; and
the M number of first wavelength selective filters each including a substrate and a multilayer film, the substrate having a light transmission property and having a first surface and a second surface opposite to each other, the multilayer film being provided on the first surface of the substrate, the first wavelength selective filters having transmission wavelength bands differing from each other, the first wavelength selective filters being configured to reflect light of wavelength bands except the transmission wavelength bands,
wherein an optical path connecting the first optical waveguide of the first collimator and the second optical waveguide of a second collimator in first order of the second collimators to each other passes through the first collimator lens, a first wavelength selective filter in first order of the first wavelength selective filters, and the second collimator lens of the second collimator in first order,
wherein the first wavelength selective filter in first order is optically coupled on the second surface of the substrate to the first collimator lens via the optical path and is optically coupled on the first surface of the substrate to the second collimator lens of the second collimator in first order via the optical path,
wherein an optical path connecting the second surface of the substrate of a first wavelength selective filter in mth (m=1, . . . , M−1) order of the first wavelength selective filters and the second optical waveguide of a second collimator in (m+1)th order of the second collimators to each other passes through the first wavelength selective filter in (m+1)th order and the second collimator lens of the second collimator in (m+1)th order,
wherein the first wavelength selective filter in (m+1)th order is optically coupled on the second surface of the substrate to the first wavelength selective filter in mth order via the optical path and is optically coupled on the first surface of the substrate to the second collimator lens of the second collimator in (m+1)th order via the optical path, and
wherein, in each of the second collimators, a focal distance of the second collimator lens and a distance between the second collimator lens and the one end of the second optical waveguide are set such that a working distance of each of the second collimators is negative.

2. The wavelength multiplexing/demultiplexing device according to claim 1,
wherein the focal distance of the second collimator lens of each of the M number of the second collimators is shorter than a focal distance of the first collimator lens.

3. The wavelength multiplexing/demultiplexing device according to claim 1,
wherein the focal distance of the second collimator lens of each of the M number of the second collimators is included in a range of ±5% from a predetermined focal distance.

4. The wavelength multiplexing/demultiplexing device according to claim 1,
wherein an interval of center wavelengths of the transmission wavelength bands between the M number of the first wavelength selective filters is 50 GHz or more in terms of frequency.

5. The wavelength multiplexing/demultiplexing device according to claim 1,
wherein an interval of center wavelengths of the transmission wavelength bands between the M number of the first wavelength selective filters is 100 GHz or more in terms of frequency.

6. The wavelength multiplexing/demultiplexing device according to claim 1,
wherein transmission wavelength bandwidths of the M number of the first wavelength selective filters are equal to each other.

7. The wavelength multiplexing/demultiplexing device according to claim 1,
wherein a transmission wavelength bandwidth of at least one of the first wavelength selective filters differs from a transmission wavelength bandwidth of each of others of the first wavelength selective filters.

8. The wavelength multiplexing/demultiplexing device according to claim 1, further comprising:
an N number (N is an integer of 2 or more) of third collimators each including a third optical waveguide and a third collimator lens optically coupled to one end of the third optical waveguide;
the N number of second wavelength selective filters each including a substrate and a multilayer film, the substrate having a light transmission property and having a first surface and a second surface opposite to each other, the multilayer film being provided on the first surface of the substrate, the second wavelength selective filters having transmission wavelength bands differing from each other and differing from the transmission wavelength bands of the M number of the first wavelength selective filters, the second wavelength selective filters being configured to reflect light of wavelength bands except the transmission wavelength bands; and
a third wavelength selective filter including a substrate and a multilayer film, the substrate having a light transmission property and having a first surface and a second surface opposite to each other, the multilayer film being provided on the first surface of the substrate, the third wavelength selective filter having a transmission wavelength band including all of the transmission wavelength bands of the M number of the first wavelength selective filters and not including any one of the transmission wavelength bands of the N number of the second wavelength selective filters, the third wavelength selective filter being configured to reflect light of wavelength bands except the transmission wavelength band,
wherein an optical path connecting the first optical waveguide of the first collimator and the third optical waveguide of a third collimator in first order of the third collimators to each other further passes through the third wavelength selective filter,
wherein the third wavelength selective filter is optically coupled on the second surface of the substrate to the first collimator lens via the optical path and is optically coupled on the first surface of the substrate to the first wavelength selective filter in first order via the optical path,
wherein an optical path connecting the second surface of the substrate of the third wavelength selective filter and the third optical waveguide of the third collimator in first order to each other passes through a second wavelength selective filter in first order of the second wavelength selective filters and the third collimator lens of the third collimator in first order,
wherein the second wavelength selective filter in first order is optically coupled on the second surface of the substrate to the third wavelength selective filter via the optical path and is optically coupled on the first surface of the substrate to the third collimator lens of the third collimator in first order via the optical path,
wherein an optical path connecting the second surface of the substrate of a second wavelength selective filter in nth (n=1, . . . , N−1) order of the second wavelength selective filters and the third optical waveguide of a third collimator in (n+1)th order of the third collimators to each other passes through a second wavelength selective filter in (n+1)th order of the second wavelength selective filters and the third collimator lens of the third collimator in (n+1)th order,
wherein the second wavelength selective filter in (n+1)th order is optically coupled on the second surface of the substrate to the second wavelength selective filter in nth order via the optical path and is optically coupled on the first surface of the substrate to the third collimator lens of the third collimator in (n+1)th order via the optical path, and
wherein, in each of the third collimators, a focal distance of the third collimator lens and a distance between the third collimator lens and the one end of the third optical waveguide are set such that a working distance of each of the third collimators is negative.

9. The wavelength multiplexing/demultiplexing device according to claim 1, further comprising:
a fourth collimator optically coupled to the second surface of the substrate of a first wavelength selective filter in Mth order of the first wavelength selective filters.

10. The wavelength multiplexing/demultiplexing device according to claim 1,
wherein the second collimator lens is a C lens.

11. The wavelength multiplexing/demultiplexing device according to claim 1,
wherein a surface of the second collimator lens facing the one end of the second optical waveguide is inclined with respect to an imaginary plane perpendicular to an optical axis of the second optical waveguide.
